(19) United States
(12) Patent Application Publication
(10) Pub. No.: US 2010/0142864 A1
(43) Pub. Date: Jun. 10, 2010

(54) OPENABLE FOOD PACKAGING

(75) Inventor: Jeffrey A. Czarny, Schaumburg, IL (US)

Correspondence Address: FOLEY & LARDNER LLP, 777 EAST WISCONSIN AVENUE, MILWAUKEE, WI, 53202-5306, US

(73) Assignee: Sara Lee Corporation

(21) Appl. No.: 12/634,564

(22) Filed: Dec. 9, 2009

Related U.S. Application Data
(63) Continuation-in-part of application No. 12/558,320, filed on Sep. 11, 2009.
(60) Provisional application No. 61/097,092, filed on Sep. 15, 2008.

(51) Int. Cl. B65D 65/28; B31B 1/14

(52) U.S. Cl. 383/207; 493/227

(57) ABSTRACT

A packaging for a food product configured to be easily openable includes a film substantially surrounding the food product and formed from a sheet having a first longitudinal side and a second longitudinal side, a seam formed by the first longitudinal side overlapping and bonding to the second longitudinal side, a tab extending beyond the seam from one of the first longitudinal side and the second longitudinal side, and at least one tear initiator provided in the film adjacent the tab, the at least one tear initiator defining a starting point for a tear path, the tear path extending generally perpendicularly from the seam

### CROSS REFERENCE TO RELATED APPLICATIONS

The present application is a continuation-in-part of U.S. patent application Ser. No. 12/558,320 titled “Openable Food Packaging” filed Sep. 11, 2009 (Attorney Docket No. 079811-0272), which claims priority under 35 U.S.C. §119 from U.S. Provisional Patent Application No. 61/097,092 titled “Openable Food Packaging” filed Sep. 15, 2008 (Attorney Docket No. 079811-0231). The full disclosures of both of these applications are hereby incorporated herein by reference.

### BACKGROUND

The present application relates generally to openable food packaging, and more specifically, to openable food products and packaging that may facilitate the opening of a packaging and/or facilitate access to or exposure of a food product provided within a packaging.

### SUMMARY

One embodiment relates to a packaging for a food product that is configured to be easily openable, the packaging comprising a film substantially surrounding the food product and formed from a sheet having a first longitudinal side and a second longitudinal side; a seam formed by the first longitudinal side overlapping and bonding to the second longitudinal side; wherein the film is formed to have directional tear properties generally perpendicular to the seam, the directional tear properties defining at least one tear path in the film.

Another embodiment relates to a packaging for a generally cylindrical food product having a longitudinal axis, the packaging comprising a film substantially surrounding the packaged food product and formed from a sheet having a pair of longitudinal sides; a seam formed by the longitudinal sides overlapping and bonding to each other; a tab extending from one of the longitudinal sides beyond the seam; at least one notch formed in the film; wherein the film is formed to have directional tear properties so that a first tear path and a second tear path are formed perpendicular to the longitudinal axis of the packaged food product when the packaging is opened by pulling on the tab.

Another embodiment relates to a packaging for a food product that is configured to be easily openable, the packaging comprising a film at least partially surrounding the food product and formed from a sheet; a packaging opening system configured to provide quick and easy access to the food product, the packaging opening system comprising a pair of tear paths extending from an edge of the film, a tab located between the tear paths, and directional tear properties formed into the film to allow pair of generally parallel tears to progress along the tear paths through the film upon pulling of the tab.

Another embodiment relates to a packaging for a food product configured to be easily openable, the packaging comprising a film substantially surrounding the food product and formed from a sheet having a first longitudinal side and a second longitudinal side; a seam formed by the first longitudinal side overlapping and bonding to the second longitudinal side; a tab extending beyond the seam from one of the first longitudinal side and the second longitudinal side; and at least one tear initiator provided in the film adjacent the tab, the at least one tear initiator defining a starting point for a tear path, the tear path extending generally perpendicularly from the seam.

Another embodiment relates to a packaging for a food product, the packaging comprising a film substantially surrounding the food product and formed from a sheet having a pair of longitudinal sides; a seam formed by the longitudinal sides overlapping and bonding to each other; a tab extending from one of the longitudinal sides beyond the seam; first and second tear initiators provided in the film and located on opposite sides of the tab; wherein the film is formulated to have directional tear properties so that a first tear path extending from the first tear initiator and a second tear path extending from the second tear initiator are formed when the packaging is opened by pulling on the tab, the first and second tear paths extending generally parallel to each other.

Another embodiment relates to a method of forming a packaging for a food product, the method comprising providing a film material; die cutting the film material to form two longitudinal sides, one of the longitudinal sides comprising a tab portion, the longitudinal sides being configured to be sealed together to form a seam; providing directional tear properties in the film material, the directional tear properties defining at least one tear path extending perpendicular to the seam.

Another embodiment relates to a packaging for a food product, the packaging comprising a film configured to substantially surround a generally cylindrical food product; and means for facilitating the opening of the packaging such that at least one tear path is formed in the film that extends generally perpendicularly to a longitudinal axis of the food product.

Another embodiment relates generally to the field of packaging for a food product comprising a film substantially surrounding the food product that is intended to be easily openable and/or closable. One embodiment of the invention includes flaps that are reclosable with adhesive. Another embodiment includes tear strips formed, for example, by perforations that partially penetrate the packaging material. Another embodiment includes a device such as a blade or flexible member (e.g., ribbon, string, wire, etc.) configured to cut (tear, rip, etc.) through all or a portion of the packaging. Another embodiment includes closure (or reclosure) devices (e.g., clips, adhesives, ties, etc.).

### BRIEF DESCRIPTION OF THE DRAWINGS

FIGS. 1A and 1B are isometric views of a packaged food product including a pair of opening tabs or flaps according to an exemplary embodiment.

FIGS. 2A-2C are isometric views of a packaged food product including a pair of overlapping tabs or flaps according to an exemplary embodiment.

FIGS. 3A and 3B are isometric and side views of a packaged food product including a film closed with a rolled seam according to an exemplary embodiment.

FIG. 4 is an isometric view of a packaged food product including a removeable longitudinal strip that may include the closed end of the product according to an exemplary embodiment. The strip may be produced by either perforating the film (laser scored, perforated, micro-perforated, cut scored, etc.) or by an overlapping glue flap.

FIG. 5 is an isometric view of a packaged food product including one or more removable longitudinal strips according to an exemplary embodiment. The strip may be produced by either perforating a film (laser scored, perforated, micro-perforated, cut scored, etc.) or by an overlapping glue flap.

FIGS. 6A and 6B are isometric views of a packaged food product including a removable longitudinal strip comprising the seam between the two edges of a film surrounding the food product according to an exemplary embodiment. The strip may be produced by perforating a film (laser score, micro-perforated, cut score).

FIG. 7 is an isometric view of a packaged food product including a removeable longitudinal strip comprising multiple layers according to an exemplary embodiment. The strip may be produced by perforating a film (e.g., laser scored, perforated, micro-perforated, cut scored, etc.).

FIG. 8 is an isometric view of a packaged food product including a removeable longitudinal strip that forms a multitude of guides or markings for cutting the food product. The guides may be perforations built into a film to assist in cutting into the food product. The strip may be produced by perforating the film (e.g., laser scored, perforated, micro-perforated, cut scored, etc.).

FIGS. 9A-9C are isometric and side views of a packaged food product including a multitude of removeable longitudinal strips according to an exemplary embodiment. The strip(s) may be produced by perforating a film (e.g., laser scored, perforated, micro-perforated, cut scored, etc.).

FIG. 10 is an isometric view of a packaged food product including a removeable lateral strip according to an exemplary embodiment. The strip may be produced by perforating a film (e.g., laser scored, perforated, micro-perforated, cut scored, etc.).

FIGS. 11A and 11B are isometric views of a packaged food product including a film that is separable along a lateral perforated line according to an exemplary embodiment. The line may be produced by perforating the film (e.g., laser scored, perforated, micro-perforated, cut scored, etc.).

FIGS. 12A and 12B are isometric and side views of a packaged food product including a multitude of removeable lateral strips that may be removed to reveal a portion of the food product according to an exemplary embodiment. The strip may be produced by perforating a film (e.g., laser scored, perforated, micro-perforated, cut scored, etc.).

FIG. 13 is an isometric view of a packaged food product including a removeable spiral strip according to an exemplary embodiment. The strips may be produced by perforating a film (e.g., laser scored, perforated, micro-perforated, cut scored, etc.).

FIGS. 14A and 14B are isometric views of a packaged food product including a multitude of lateral cutting guides and a longitudinal perforation according to an exemplary embodiment. The cutting guides and/or the perforations can be exposed or hidden under a tuck flap. The strip may be produced by perforating a film (e.g., laser scored, perforated, micro-perforated, cut scored, etc.).

FIG. 15 is an isometric view of a packaged food product including a longitudinal perforated cutting guide and a multitude of lateral perforations according to an exemplary embodiment.

FIG. 16 is an isometric view of a packaged food product including a longitudinal perforated cutting guide and a multitude of lateral perforations according to an exemplary embodiment.

FIG. 17 is an isometric view of a packaged food product including a multitude of differentiated lateral perforations according to an exemplary embodiment. The perforations may be used as cutting guides.

FIGS. 18A and 18B are isometric views of a packaged food product including a pull ribbon or thread that may cut through a film along a longitudinal path according to an exemplary embodiment.

FIGS. 19A and 19B are isometric and partial side views of a packaged food product including a pull ribbon or thread that may cut through a film along multiple longitudinal paths according to an exemplary embodiment.

FIGS. 20A and 20B are isometric views of a packaged food product including a pull ribbon or thread that may cut through a film along a longitudinal and/or lateral path according to an exemplary embodiment.

FIGS. 21A and 21B are isometric and side views of a packaged food product including two pull ribbons or threads that may cut through a film along lateral paths according to an exemplary embodiment.

FIGS. 22A and 22B are isometric and schematic views of a packaged food product including a pull ribbon or thread that may cut through a food product and through a film along a lateral path according to an exemplary embodiment.

FIGS. 23A and 23B are isometric views of a packaged food product including multiple pull ribbons or threads that cut through a film along lateral paths according to an exemplary embodiment. The ends of the pull ribbons may be hidden under a flap. The flap may also be perforated to assist in opening.

FIG. 24 is an isometric view of a packaged food product including a pull ribbon or thread that cuts through a film along a spiral path according to an exemplary embodiment.

FIG. 25A is an isometric view of a packaged food product including a film that is closed with a clip with rounded ends according to an exemplary embodiment.

FIG. 25B illustrates a clip that is designed to twist open according to an exemplary embodiment.

FIG. 26A is an isometric view of a packaged food product including a film that is closed with a spring-loaded clip according to an exemplary embodiment.

FIGS. 26B and 26C illustrate spring-loaded clips according to two exemplary embodiments.

FIG. 27A is an isometric view of a packaged food product including a film that is closed with a breakable clip according to an exemplary embodiment.

FIG. 27B illustrates a breakable clip according to an exemplary embodiment.

FIGS. 28A and 28B are isometric views of a packaged food product including a film that is closed with a clip comprising a blade to cut the film according to an exemplary embodiment.

FIG. 28C illustrates a clip according to an exemplary embodiment.

FIG. 29A is an isometric view of a packaged food product including a film that is closed with a replaceable clip according to an exemplary embodiment.

FIG. 29B illustrates a replaceable clip according to an exemplary embodiment.

FIG. 30A is an isometric view of a packaged food product including a film that is closed with a replaceable clip according to an exemplary embodiment.

FIG. 30B illustrates a replaceable clip according to an exemplary embodiment.

FIG. 31A is an isometric view of a packaged food product including a film that is closed with a replaceable clip with a ratcheting feature according to an exemplary embodiment.

FIG. 31B illustrates a replaceable clip according to an exemplary embodiment.

FIG. 32A is an isometric view of a packaged food product including a film that comprises one or more internal fastening members according to an exemplary embodiment.

FIG. 32B illustrates a film having internal fastening members according to an exemplary embodiment.

FIGS. 33A and 33B are isometric views of a packaged food product including a film that comprises one or more internal adhesive portions according to an exemplary embodiment.

FIG. 34A is an isometric view of a packaged food product including a device for tearing the film surrounding the food product according to an exemplary embodiment.

FIG. 34B illustrates a device for tearing a film according to an exemplary embodiment.

FIG. 34C illustrates various directions or orientations in which the device of FIG. 34B may be used.

FIG. 35 is an isometric view of a packaged food product according to an exemplary embodiment.

FIG. 36 is a fragmentary view of a sheet of film used for the product packaging of FIG. 35.

FIGS. 37A-37C is a series of images showing a method of opening packaging according to an exemplary embodiment.

FIGS. 38A-38C is a series of images showing an alternative method of opening packaging according to an exemplary embodiment.

FIG. 39 is a fragmentary view of the features that provide opening of the packaging according to an exemplary embodiment.

FIG. 40 is a fragmentary view of the features that provide opening of the packaging according to another exemplary embodiment.

FIG. 41 is a fragmentary view of the features that provide opening of the packaging according to another exemplary embodiment.

FIG. 42 is a front view of a packaging in an unrolled configuration according to an exemplary embodiment.

FIG. 43 is a cross section view of a film material according to an exemplary embodiment.

FIG. 44 is a cross section view of a film material according to another exemplary embodiment.

FIG. 45 is a perspective view of a packaging for food product according to an exemplary embodiment.

FIG. 46 is a front view of the packaging for food product of FIG. 45 according to an exemplary embodiment.

### DETAILED DESCRIPTION

Before proceeding to the detailed description of exemplary embodiments, several comments can be made about the general applicability and the scope thereof.

The present invention relates generally to the field of packaging for a food product comprising a film substantially surrounding the food product that is intended to be easily openable and/or closable. One embodiment of the invention includes flaps that are reclosable with adhesive. Another embodiment includes tear strips formed, for example, by perforations that partially penetrate the packaging material. Another embodiment includes a device such as a blade or flexible member (e.g., ribbon, string, wire, etc.) configured to cut (tear, rip, etc.) through all or a portion of the packaging. Another embodiment includes closure (or reclosure) devices (e.g., clips, adhesives, ties, etc.). Any of these components may facilitate the opening of a packaging in a longitudinal fashion (e.g., in a direction generally parallel to a longitudinal axis of or along a length of a package or food product), a lateral fashion (e.g., perpendicular to a longitudinal axis, radially about a longitudinal axis, and/or radially in a plane that is perpendicular to a longitudinal axis of a package or food product), a combination of longitudinal fashion and lateral fashion (e.g., in a spiral or helix direction along exterior surface), or an any other direction, fashion, or manner.

As used in this description, “food product” or “prepared foods” includes whole, ground, blended, and/or emulsified meat and non-meat products (e.g., soy-based protein) in a an extruded or otherwise formed roll, commonly referred to as a “chub” that is packaged in an outer skin, film, or wrapper. The application is directed to ripping, cutting, puncturing, or otherwise opening the film to expose the food product so that it may be used by a consumer. According to other exemplary embodiments the film may be used to house another food product such as cookie dough. One or more package opening facilitators (e.g., perforations, cutting devices, tear ribbons, weakened portions of material, notches, cuts, scores, etc.), may be used according to the various embodiments described herein, the features of which may be used alone or in any combination.

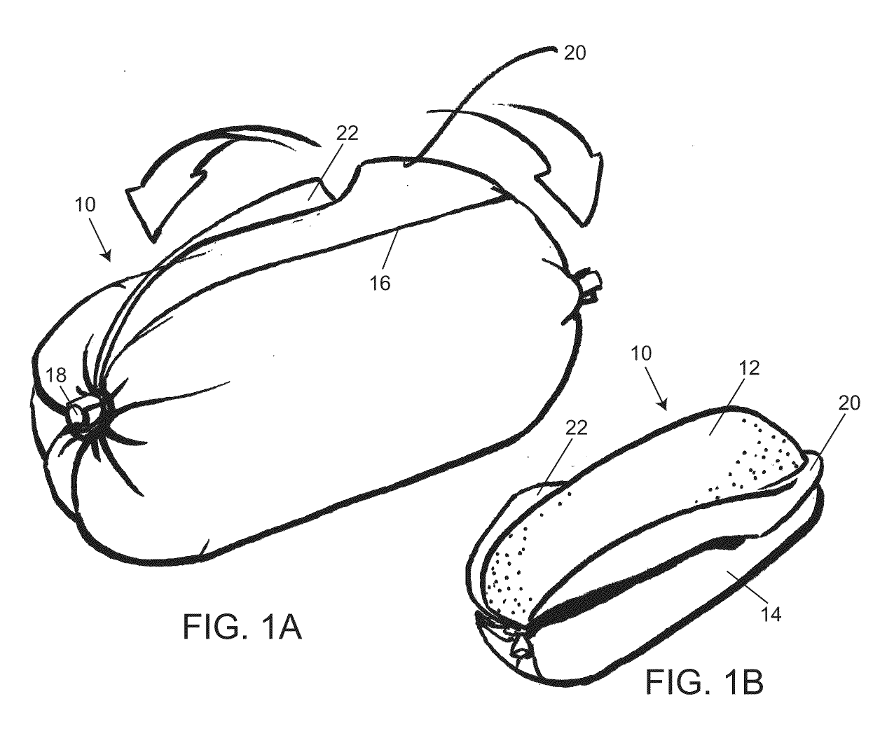

Referring to FIGS. 1A-1B, a product 10 including a food product 12 (e.g., a chub roll) is shown according to an exemplary embodiment. The chub roll is a generally cylindrical body of food product such as ground meat. Food product 12 is surrounded by a film 14 (e.g., a packaging container, etc.) that is configured to retain food product 12 and act as a barrier between food product 12 and the atmosphere. According to an exemplary embodiment, film 14 is a multi-layered member that is formed from a variety of materials such as nylon and polyester. Each of the layers may be configured for a different purpose. For example, different layers may be configured to provide puncture resistance to the film, provide tear resistance to the film, provide an oxygen barrier for the film, etc. Film 14 is formed as a flat sheet, with two edges or longitudinal sides of film 14 coupled together at a longitudinal seam 16 to form a hollow tube. After being filled with food product 12, film 14 is gathered and closed on either end 18 of food product 12 with a closure device, commonly embodied as a metal staple or clip. Food product 12 may be cut into slices, such as sausage patties, or may be used in bulk, such as ground beef.

As shown in FIGS. 1A and 1B, the edges of film 14 may extend beyond seam 16 and form two flaps or tabs 20, 22. A user may grasp tabs 20, 22 and pull them in opposite directions to open film 14 at seam 16 and expose food product 12. As the user pulls tabs 20, 22 apart, they may push on the bottom of product 10 (e.g., opposite of the seam), to push food product 12 out of film 14. Seam 16 and/or tabs 20, 22 may include a re-sealable adhesive or other structure to allow a user to re-close film 14 after opening.

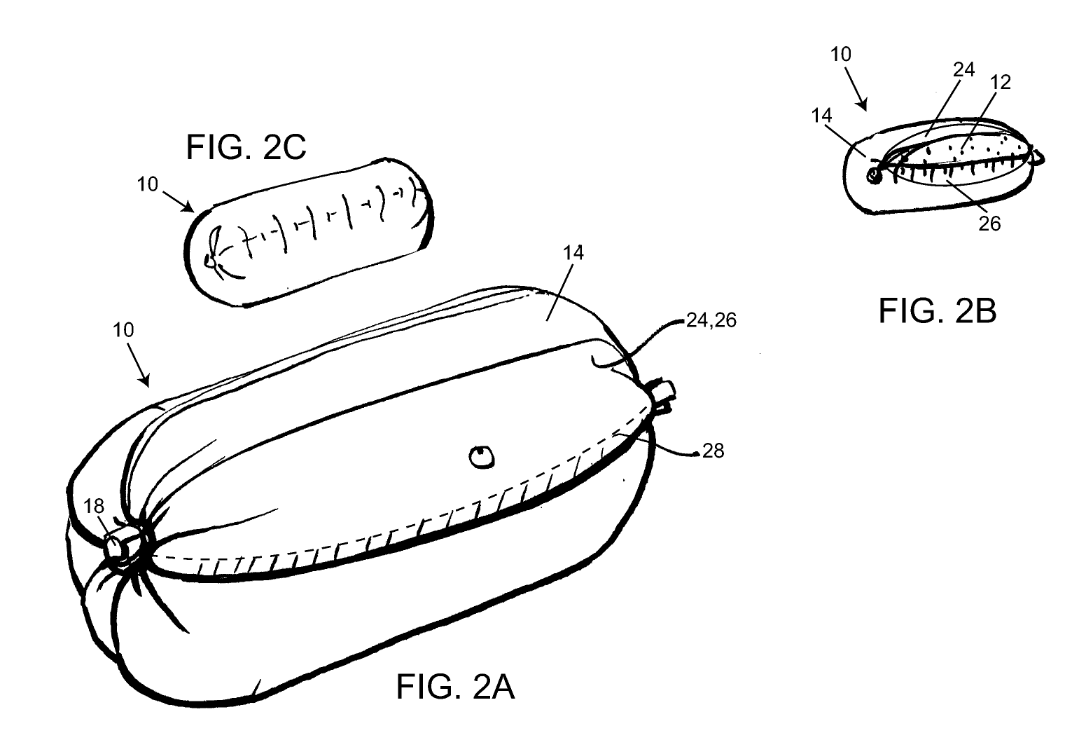

As shown in FIGS. 2A-2C, the edges of film 14 may form flaps 24, 26 that overlap and interlock. A user may peel back flaps 24, 26 to reveal and dispense food product 12 (see FIG. 2B), and overlap flaps 24, 26 again to close film 14. A resealable portion 28 (e.g., an adhesive portion, etc.) may be used to reseal flaps 24, 26 after opening. FIG. 2C shows the bottom of product 10 according to an exemplary embodiment.

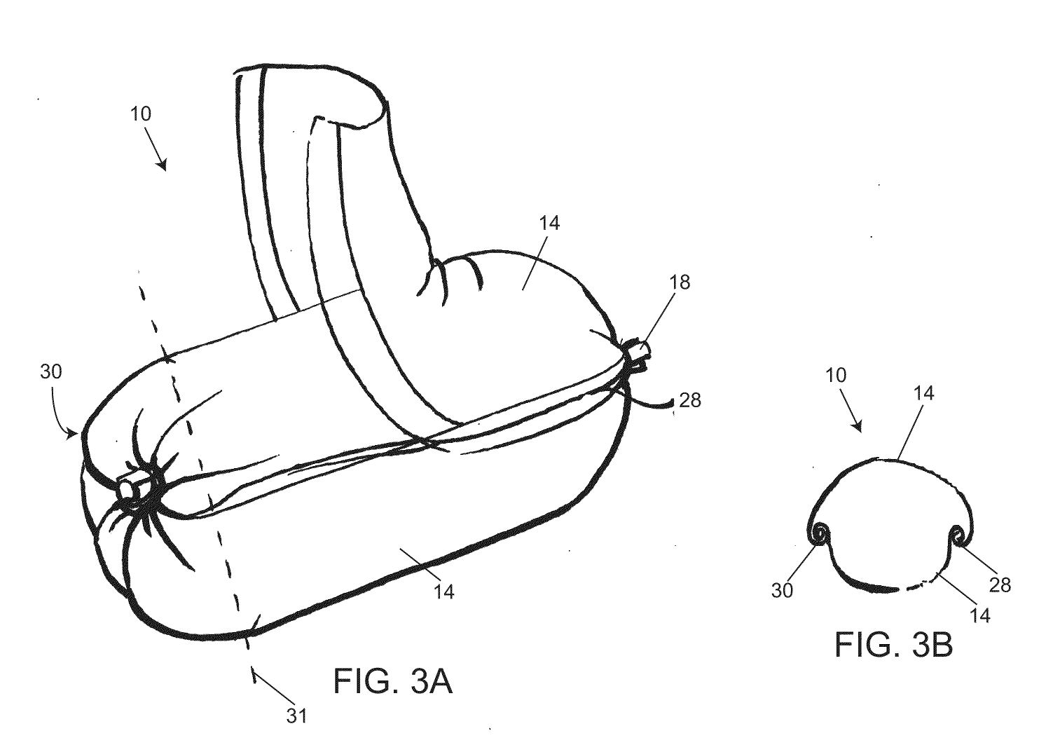

As shown in FIGS. 3A and 3B, two pieces of film 14 may surround food product 12 and be joined at two seams 28, 30. The edges of the two pieces of film 14 may be curled or folded together such that, when the ends of film 14 are gathered and closed (i.e. with a metal staple or clip), seams 28, 30 form rolled seams and may be difficult to open. However, if an end of product 10 is cut (e.g., at line 31), one or both of the pieces of film 14 may be peeled back, opening rolled seams 28, 30. According to another exemplary embodiment, food product 12 may be surrounded by a single piece of film 14 and only one rolled seam (e.g., a rolled seam similar to one of rolled seams 28, 30) may be provided.

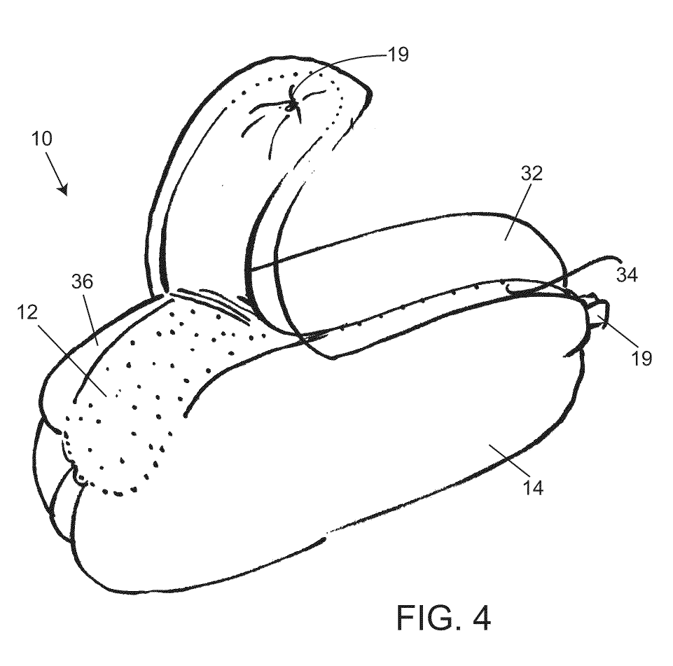

Referring now to FIGS. 4-13, film 14 may include one or more removeable strips to facilitate the opening of film 14 and allow a user to dispense all or a portion of food product 12. According to one exemplary embodiment, the removeable strip may be defined by a perforation in film 14 (e.g., a weakened area of film 14 that is created by a slight incision into the top layer of film 14.). According to another exemplary embodiment, the removeable strip may be formed by a separate strip of film material that is coupled to the rest of film 14 with an adhesive.

As shown in FIG. 4, a removeable strip 32 may comprise the portion of gathered film 14 surrounding clip 19 on end 18 of product 10. Clip 19 and the surrounding bunched film may be used as a handle by the user to begin to remove removeable strip 32. In one embodiment, removeable strip 32 is resealably adhered to film 14 via sealable portions 34, 36. Strip 32 is produced by either perforating film 14 (laser scored, perforated, micro-perforated, cut scored, etc.) or by an overlapping glue flap such as sealable portions 34, 36.

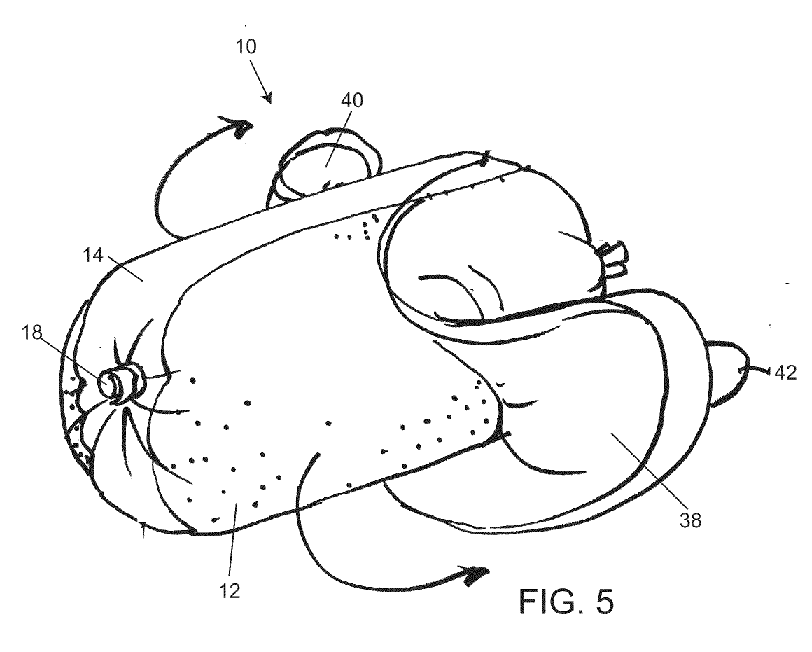

As shown in FIG. 5, a removeable strip 38, 40 may exclude the portion of the gathered film surrounding clip 19 on the end of a roll. The removeable strip 38, 40 may include a tab or protrusion 42 that may be grasped by a user to remove removeable strip 38, 40. According to one exemplary embodiment, two removeable strips 38, 40 are provided. When strips 38, 40 are removed, the remaining film 14 may be easily removed from food product 12.

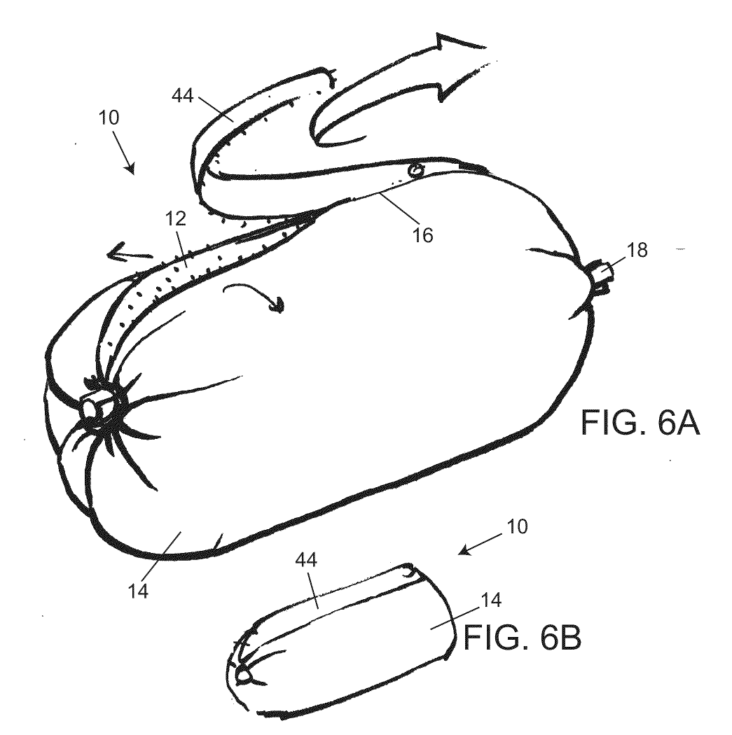

As shown in FIGS. 6A and 6B, a removeable strip 44 may comprise a seam 16 where two edges of film 14 are coupled together. According to one exemplary embodiment, the edges of film 14 are heat sealed together to form a flap. The flap may be grasped by the user and removed along perforations on either side of the flap.

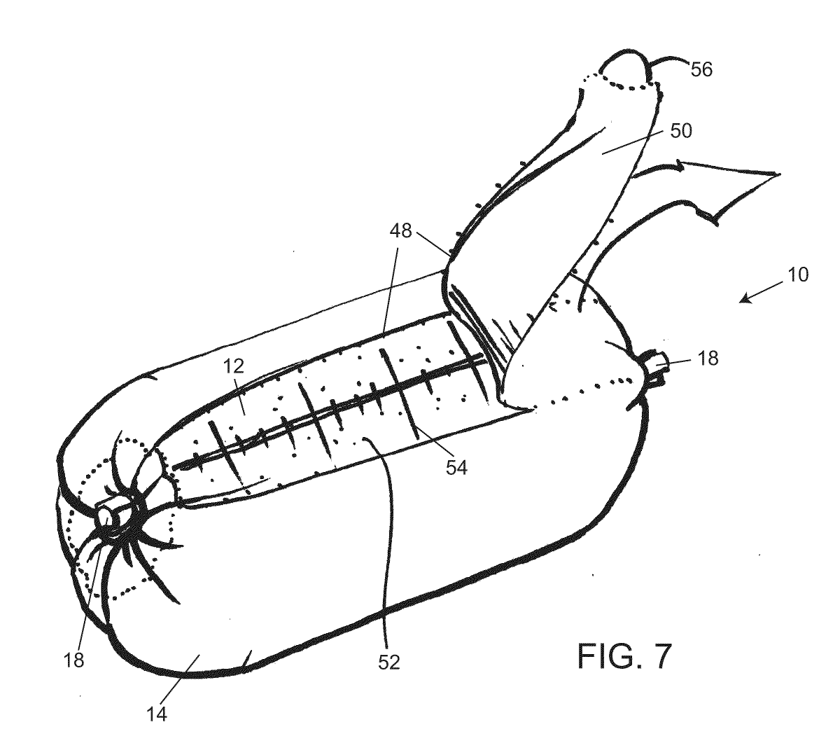

As shown in FIG. 7, a removeable strip 48 may comprise several layers. According to an exemplary embodiment, a first or outer portion 50 of strip 48 is opaque. Outer portion 50 may be pulled away to reveal a second or transparent layer 52. Transparent layer 52 allows a user to view food product 12 and may include a series of markings 54 that are configured to facilitate the cutting of food product 12 into a multitude of generally equally thick slices. Outer portion 50 may include a tab 56 and be pulled from one side of product 10 to the opposite side. At the opposite side, outer portion 50 may be coupled to transparent layer 52 such that, when pulled back towards the first end, outer portion 50 and transparent layer 52 may be removed. With both layers removed, a user may dispense all or a portion of a food product 12.

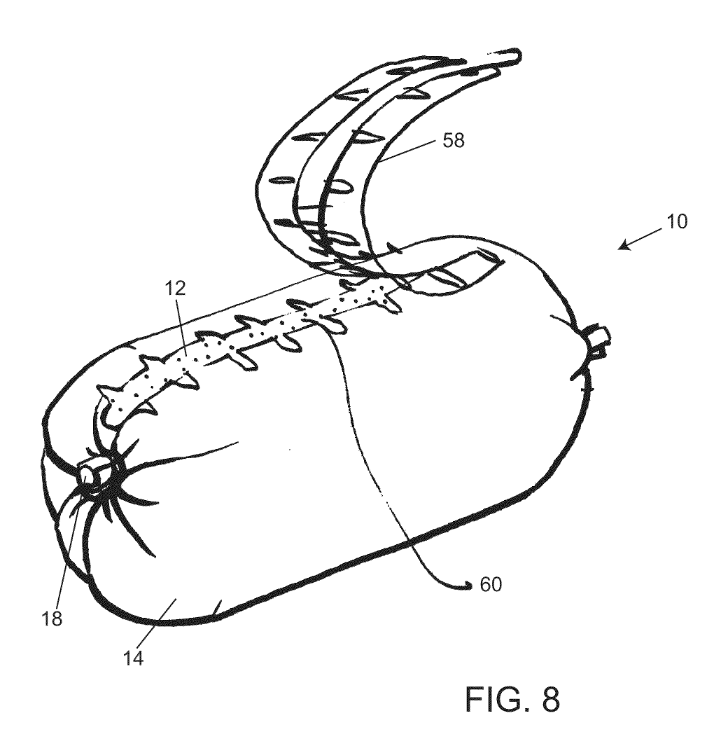

As shown in FIG. 8, a removeable strip 58 may reveal a series of lateral notches or cutouts 60 when removed. Notches 60 are configured to facilitate the cutting of food product 12 into a multitude of generally equally thick slices. Notches 60 may also provide a starting point for a knife so that a user may more easily cut through film 14.

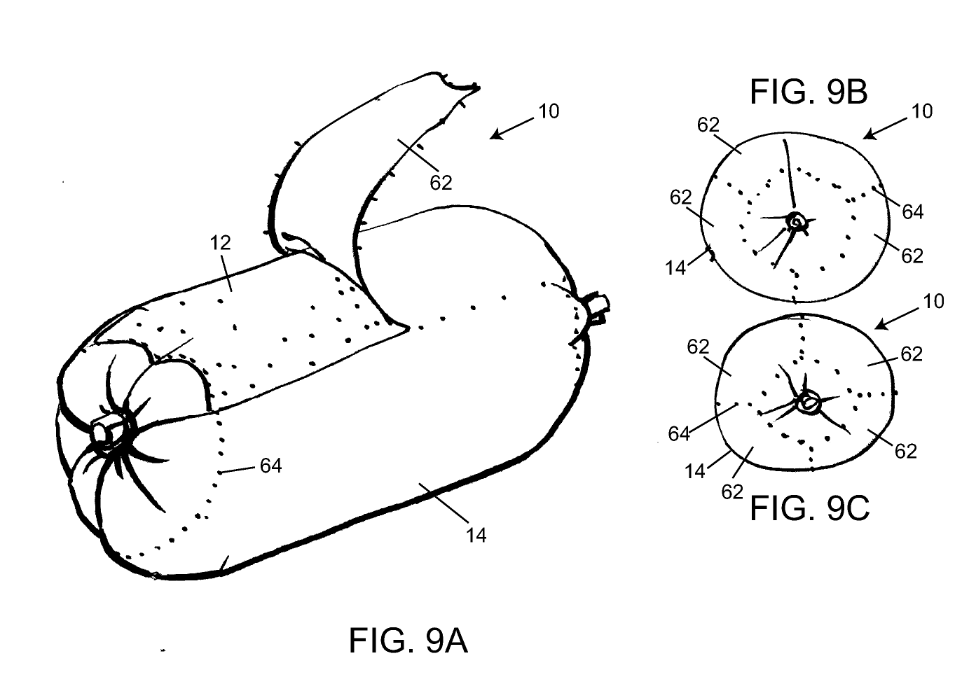

As shown in FIGS. 9A-9C, film 14 may include multiple removeable longitudinal strips 62 (e.g., one, two, three, four or more, etc.). One or more cut lines 64 (e.g., perforations, etc.) may be provided to define and facilitate opening of film 14 and removal of strips 62. For example, FIG. 9A shows a single strip 62, FIG. 9B shows 3 strips 62, and FIG. 9C shows 4 strips 62.

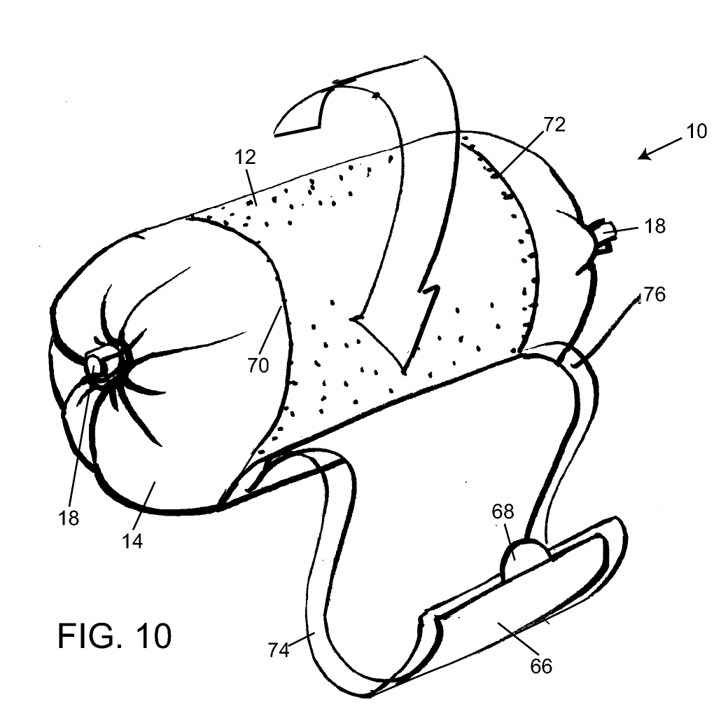

As shown in FIG. 10, a removeable strip 66 may be oriented generally laterally (rather than longitudinally) around food product 12. After a user removes strip 66, the gathered ends of film 14 may be easily removed from food product 12. As shown in FIG. 10, seams 70, 72 may define strip 66, and may include perforations or other similar features that facilitate removal of strip 66. Further, sealable portion 74 (e.g., clear sealable or resealable flaps, etc.) may be provided on opposite edges of strip 66 to permit strip 66 to be re-sealed. Strip 66 may include a tab 68 usable by a user to pull strip 66 away from film 14. Further, strip 66 may extend around all or a portion of food product 12.

In some embodiments, film 14 substantially surrounds food product 12, and may be formed from a sheet of material that is foldable such that the longitudinal sides of the sheet of materials may form a seam that runs along the length of product 10. During forming of the sheet or film, directional tear properties may be formed to facilitate removal of pull strip 66, such as scores, perforations, notches, micro-scores, etc. These directional tear properties may define one or more tear paths in film 14. For example, as shown in FIG. 10, film 14 is formed such that strip 66 is defined by generally parallel tear paths shown as seams 70, 72.

As discussed above, tab 68 is usable to pull strip 66 away from the remainder of film 14. In some embodiments, tab 68 may be integrally formed as part of film 14. In other embodiments, tab 14 may be formed separately from film 14 and then attached to film 14 using adhesives, heat sealing, or another appropriate means.

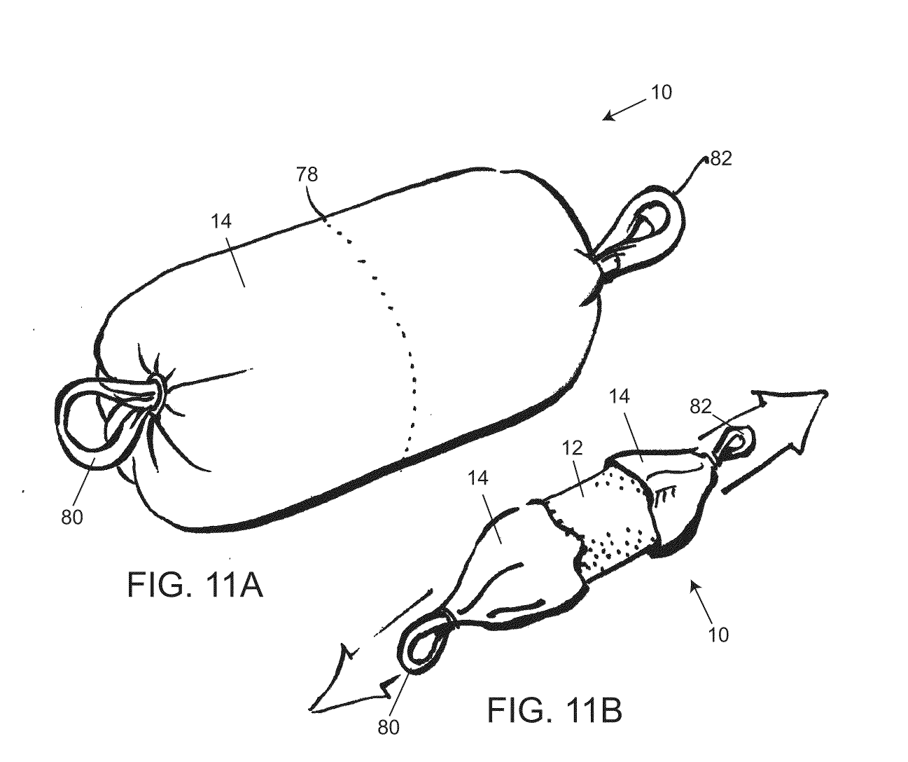

As shown in FIGS. 11A and 11B, according to an exemplary embodiment, film 14 may include a lateral perforation 78. Film 14 may extend beyond clips on the ends of food product 12 and doubled back to form handles 80, 82 (e.g., loops, hooks, graspable portions, etc.) that may be grasped by a user. When a user pulls outward on the ends of film 14 via handles 80, 82, film 14 may rupture or tear along perforation 78 into two portions that may be easily removed from food product 12 in opposite directions (see FIG. 11B). Alternatively, film 14 may be configured to be torn along perforation 78 first (e.g., via a removable strip, perforation, etc.) then pulled outward via handles 80, 82 on the ends of film 14.

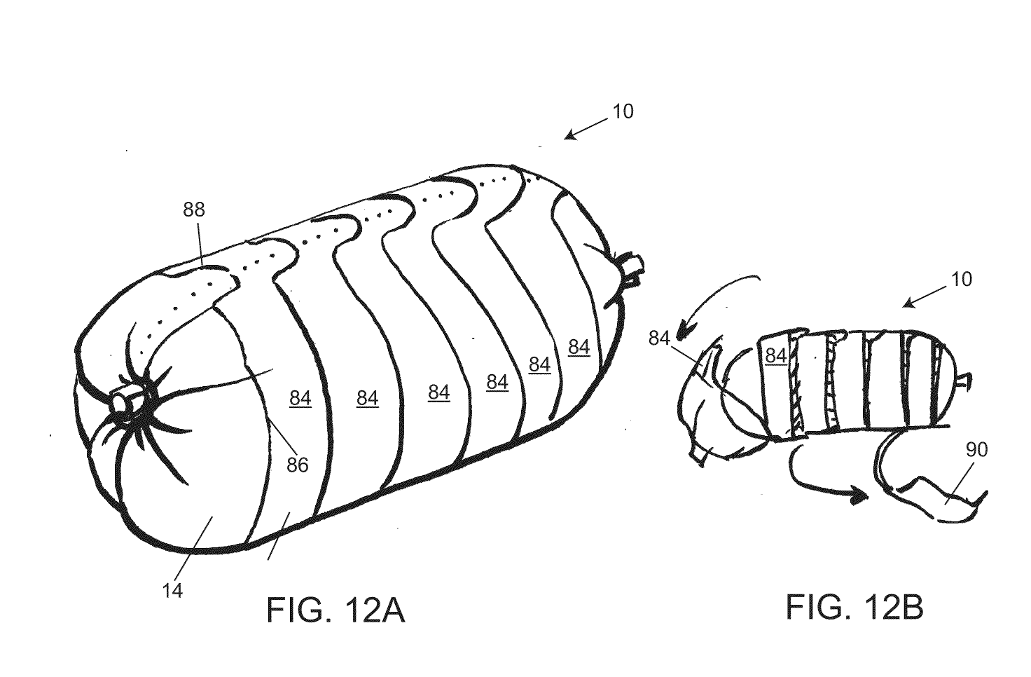

As shown in FIGS. 12A and 12B, film 14 may include multiple removable lateral strips 84. Strips 84 may be formed by a series of lateral perforations 86, or may be multiple panels that overlap and are coupled together with an adhesive. Strips 84 may include an extending tab 88 to facilitate the removal of each strip 84. A user may remove only some of strips 84 to expose only a portion of food product 12. According to an exemplary embodiment, film 14 may also include a longitudinal strip 90 (e.g., on the bottom of product 10) such that, after one of lateral strips 84 has been separated from the next lateral strip 84, the separated lateral strip 84 may be pulled further to longitudinal strip 90 (see FIG. 12B) and completely open product 10.

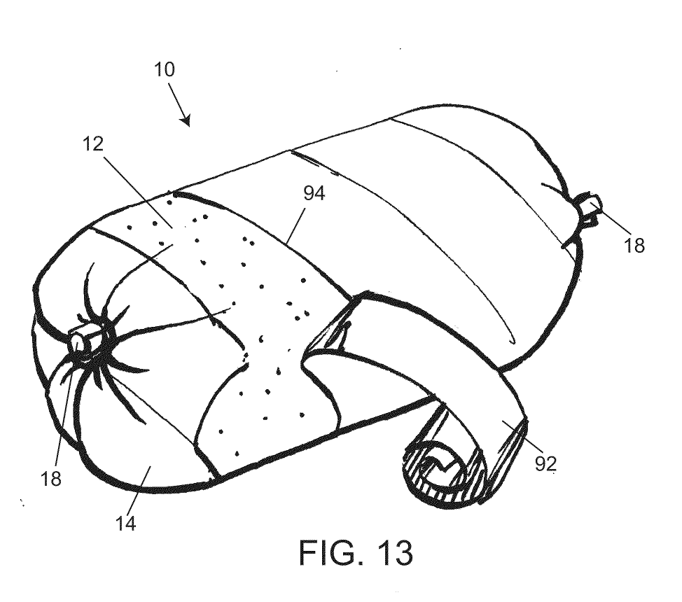

As shown in FIG. 13, a film 14 may include a spiral strip 92. Strip 92 may be formed by a spiral perforation 94 or the strip may be coupled to itself with an adhesive. Strip 92 may be pulled or unwound to expose all or a portion of food product 12, and strip 92 may overlap itself to ensure coverage of food product 12 and/or provide a base for adhesives.

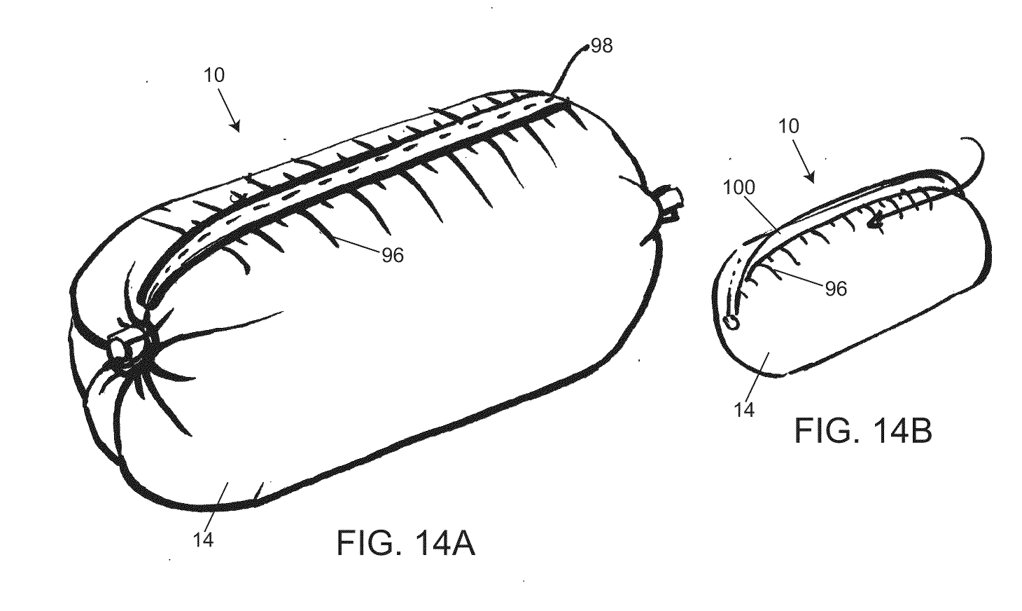

Referring to FIGS. 14-17, film 14 may include a series of lateral markings or features (e.g., guide markings, etc.) that are configured to facilitate cutting of food product 12 into a multitude of generally equally thick slices. According to various exemplary embodiments, the guide markings may be printed on film 14, formed by creases in film 14, or may be formed by perforations in film 14.

As shown in FIGS. 14A and 14B, guide markings 96 may be provided proximate to a seam 98 in film 14. Seam 98 where the edges of film 14 are coupled together to form a flap a 100 (e.g. with a heat seal) may be colored distinctly from the rest of film 14 to call attention to guide markings 96. According to one exemplary embodiment, guide markings 96 may be exposed and visible. According to another exemplary embodiment, guide markings 96 may be concealed below flap 100.

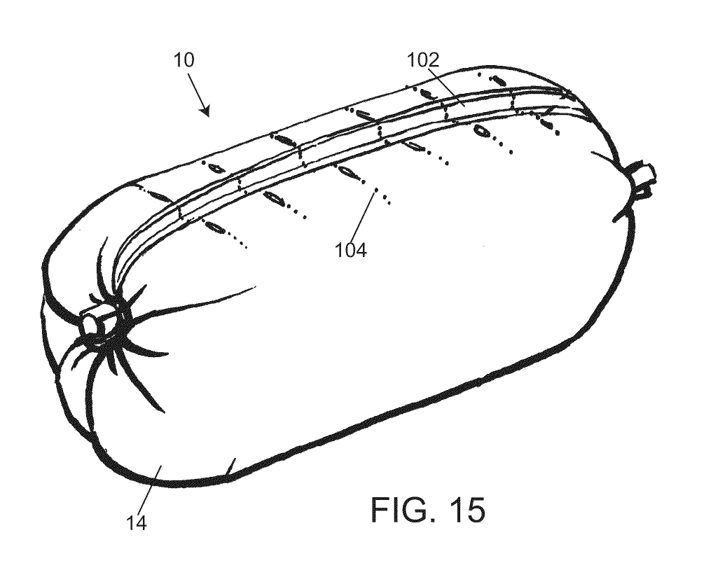

As shown in FIG. 15, film 14 may include a longitudinal cutting guide 102 and lateral guide markings 104. Longitudinal cutting guide 102 facilitates the opening of the packaging with a longitudinal cut (e.g., using a knife). Lateral guide markings 104 facilitate the cutting of the food product into individual slices. In some embodiments, markings 104 may include perforations, micro-perforations, scores, micro-scores, notches, etc., and may define tear paths that extend generally parallel relative to one another and in a perpendicular fashion to the longitudinal axis of product 10. The spacing between markings 104 may vary, such that the distance between adjacent markings may be constant or may vary along the length of product 10 (e.g., to provide widths of varying amounts between markings to accommodate different portion sizes, etc.). Markings 104 may extend around all or a portion of product 10, which may have a generally cylindrical shape along a substantial portion of its length. In some embodiments, markings 104 may be usable as a starter for a knife or other cutting device. In other embodiments, markings 104 may be usable to facilitate manual tearing or ripping of film 14 (e.g., by a user puling on a tab provided between one or more of markings 104).

As discussed with respect to FIG. 10, cutting guide 102 and/or markings 104 may be formed in film 14 to provide directional tear properties that define tear paths in film 14 to facilitate opening product 10 and exposing all or a portion of the food product provided within film 14. Further, the number and sizing of markings may vary according to various exemplary embodiments.

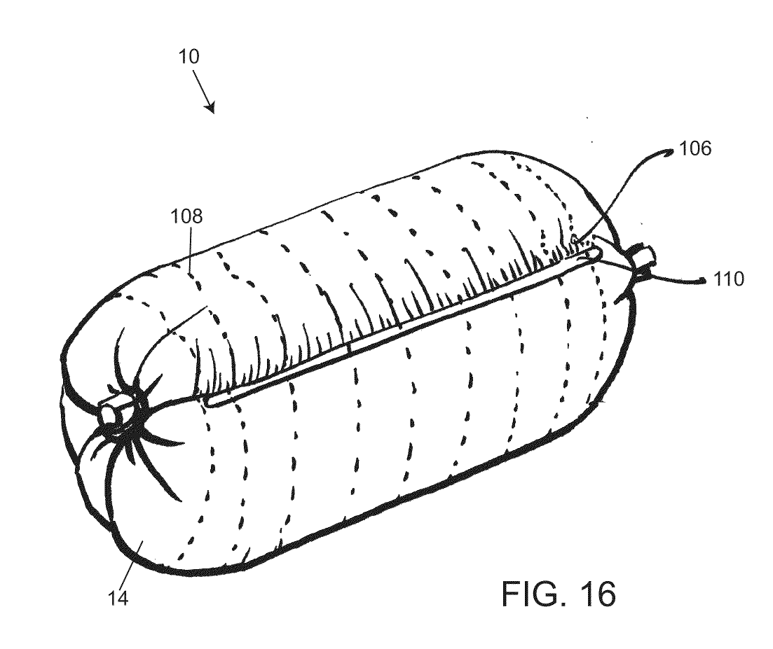

As shown in FIG. 16, film 14 may include a first guide marking 106 and a second guide marking 108. According to an exemplary embodiment, first guide marking 106 includes a ruler or other marking proximate to a longitudinal cutting guide 110, and the second guide marking 108 includes a series of lateral perforations that extend around the circumference of film 14 along the longitudinal axis of product 10. The perforations may be provided at predetermined locations along the length of product 10, such as to divide a food product into slices of recommended thickness.

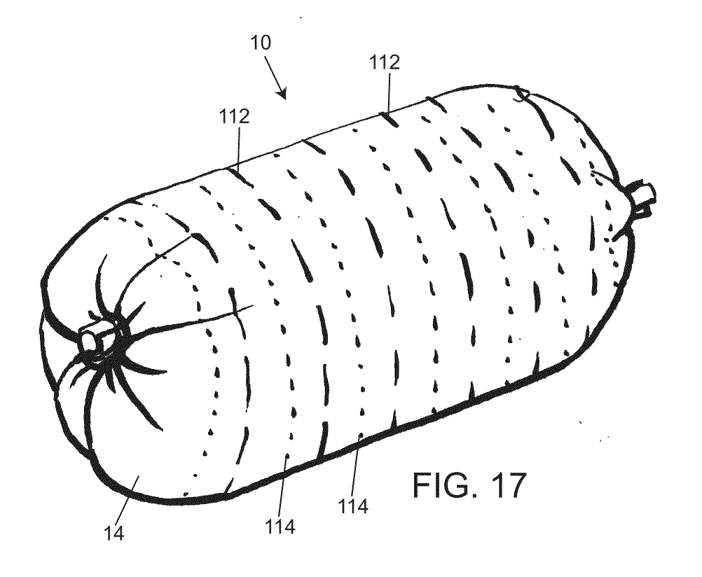

A shown in FIG. 17, film 14 may include a first series of lateral perforations 112 and a second series of lateral perforations 114 spaced along the longitudinal axis of product 10. First perforations 112 and second perforations 114 may be provided to indicate different recommended cutting patterns. For example, first perforations 112 may indicate larger (e.g., thicker) patties while second perforations 114 may indicate smaller (e.g., thinner) patties. Perforations 112, 114 may further include other features such as scores, micro-scores, notches, etc. to facilitate opening film 14 and exposing all or a portion of food product 12. The width between perforations 112, 114 may vary, and the appearance between perforations 112 and perforations 114 may be varied such that a user may easily differentiate between the different sets of perforations.

A longitudinal cutting guide, mark, or removeable strip, as shown for example in FIG. 15, may further be provided to further facilitate the removal of film 14. In some embodiments, one or more tabs may be provided between one, some, or all of perforations 112, 114. The specific configuration of perforations 112, 114 may be varied to suit a particular application.

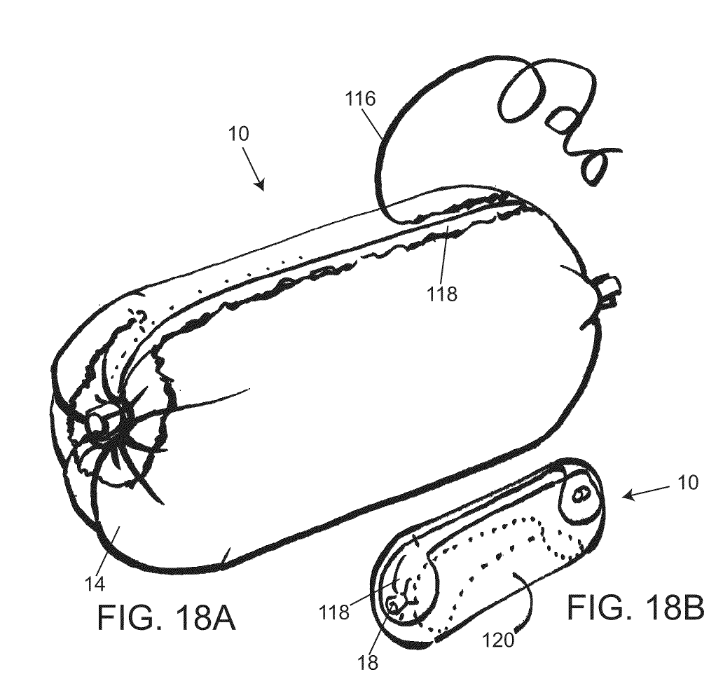

Referring now to FIGS. 18-24, film 14 may include one or more tear ribbons (e.g., cords, threads, tapes, etc.) to facilitate the opening of film 14 and allow a user to dispense all or a portion of food product 12. The ribbon is pulled by a user and tears or ruptures film 14. According to an exemplary embodiment, perforations may be included in film 14 along the path of the ribbon to facilitate the tearing of film by the tear ribbon.

As shown in FIGS. 18A and 18B, tear ribbon 116 divides the film into a removable portion 198 (e.g., first portion) and area 120 (e.g., second portion). First portion 118 comprises the portion of film 14 around one or both of ends 18 of film 14 gathered by a clip (e.g., to secure ends 18) and a longitudinal strip connecting the two ends 18. The first portion is removed after the ribbon 116 separates first portion 118. Second portion 120 comprises the remaining film, which may be used by the user to grasp product 10 while opening film 14 (e.g., to avoid directly touching the food product). In one embodiment the ribbon may be provided so as to define a removable portion of film 14 that includes one or both of ends 18. As shown in FIG. 18B, product 10 may be configured to be graspable on an area 120 (e.g., hand hold area) while ribbon 116 is being removed.

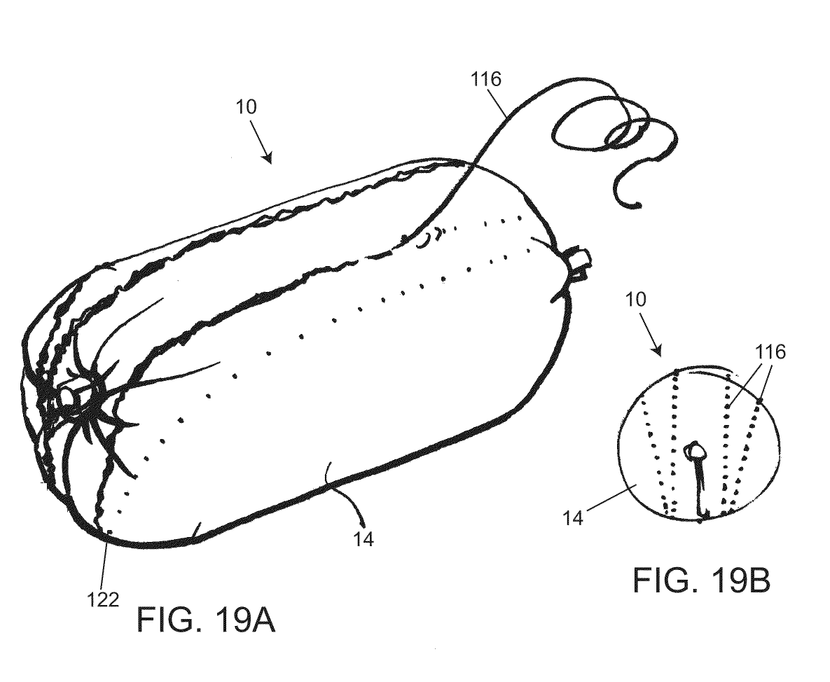

As shown in FIGS. 19A and 19B, tear ribbon 116 may cross the length of product 10 with a multitude of longitudinal paths (e.g. in a zig-zag manner). One or more perforated portions may facilitate removal of ribbon 116. Further, an overlap point 122 maybe provided at the end of product 10 to permit a change in direction of ribbon 116.

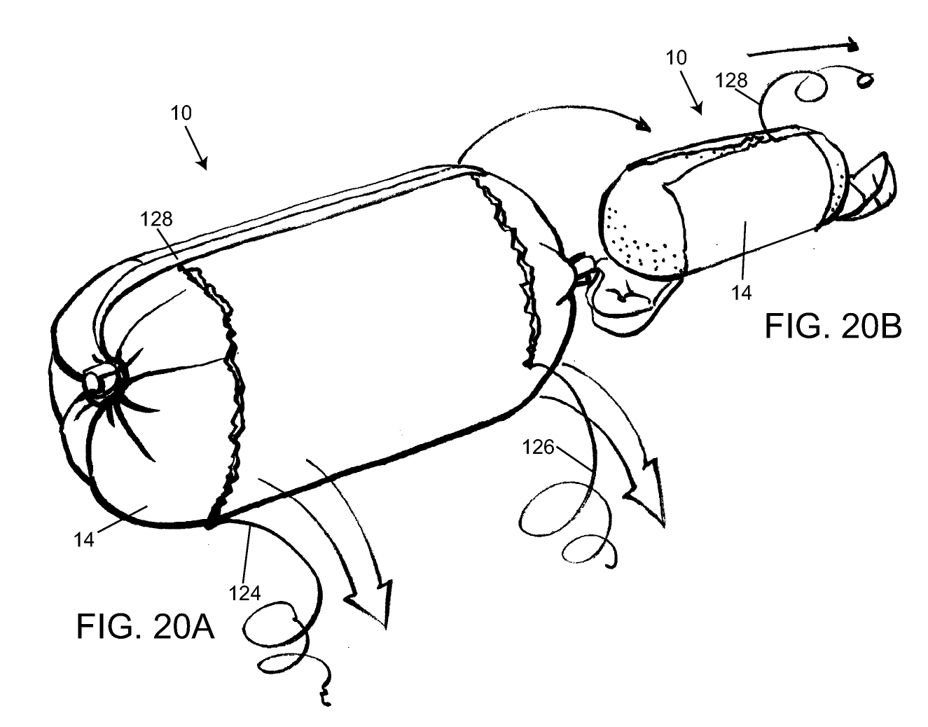

As shown in FIGS. 20A and 20B, first and second tear ribbons 124, 126 may be provided at opposite ends of product 10. First and second tear ribbons 124, 126 follow lateral paths to the ends of film 14 from the central portion of product 10. A third tear ribbon 128 may follow a longitudinal path to cut the central portion of film 14 and allow film 14 to be removed from food product 12.

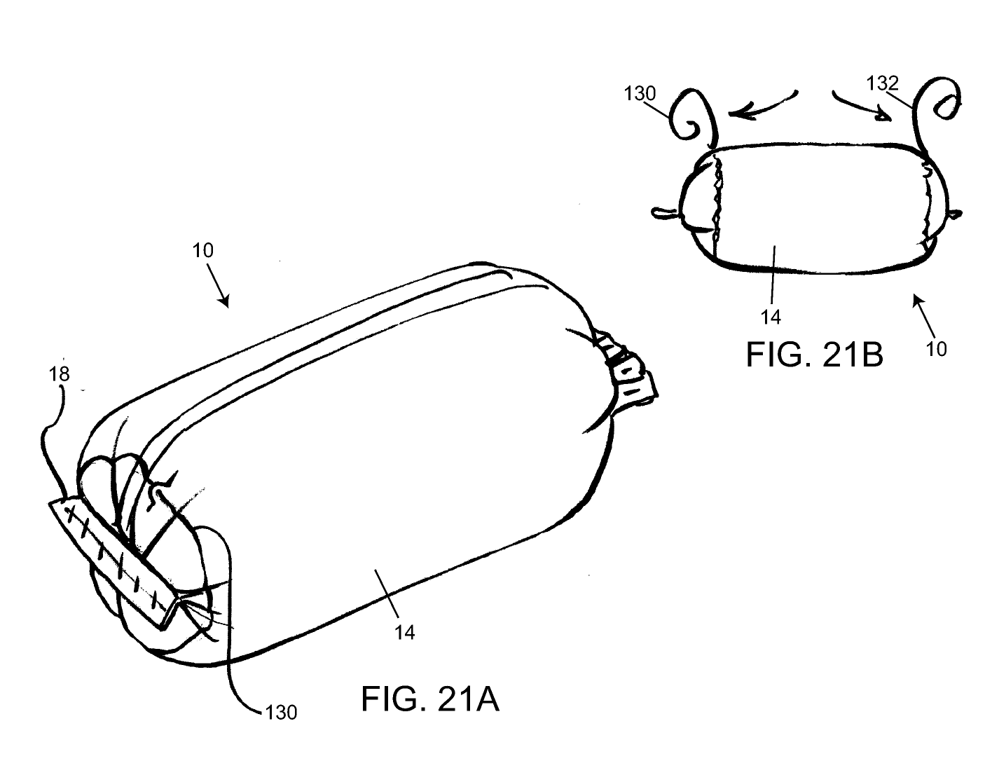

As shown in FIGS. 21A and 21B, first and second tear ribbons 130, 132 may be provided at opposite ends of product 10. First and second tear ribbons 130, 132 follow lateral paths to separate the ends of film 14 from the central portion of film 14. Also, ends 18 of film 14 may be heat sealed instead of gathered and held together with a clip. A longitudinal tear ribbon may also extend along the length of product 10 between tear ribbons 130, 132.

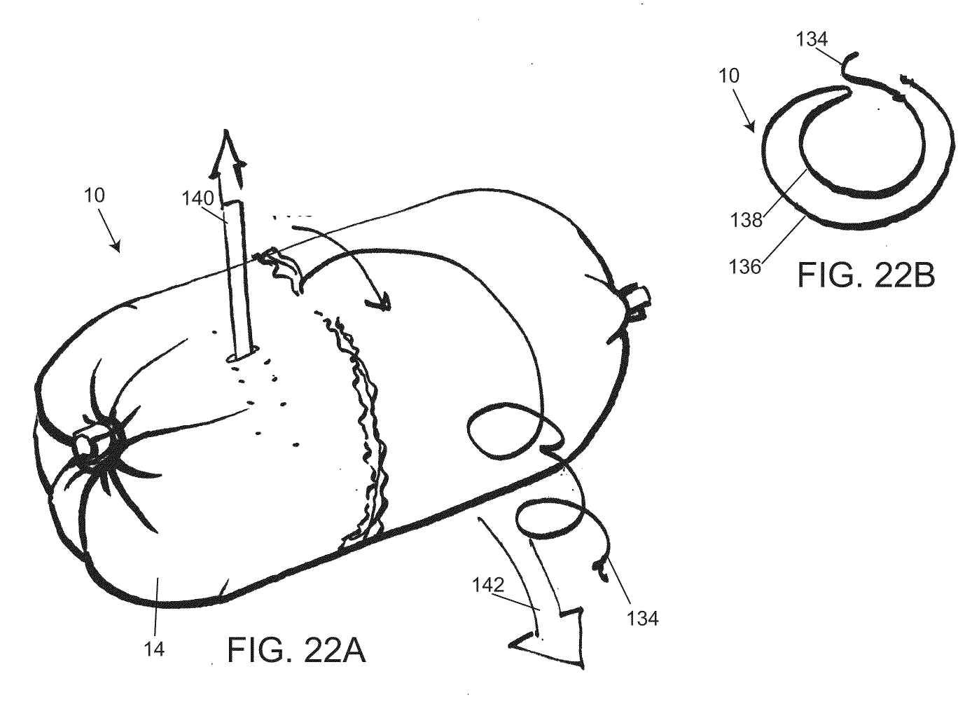

As shown in FIGS. 22A and 22B, a tear ribbon 134 may cut food product 12 as well as film 14 surrounding food product 12. According to an exemplary embodiment, tear ribbon 134 forms a first or outer loop 136 and a second or inner loop 134, as schematically shown in FIG. 22B. A user grasps the end of tear ribbon 134 and pulls to pull the length of inner loop 138 out of film 14 (see arrow 140), cutting through food product 12. As the user continues to pull tear ribbon 134 along outer loop 136 (see arrow 142), it cuts through film 14 similar to the embodiments of FIGS. 20 and 21.

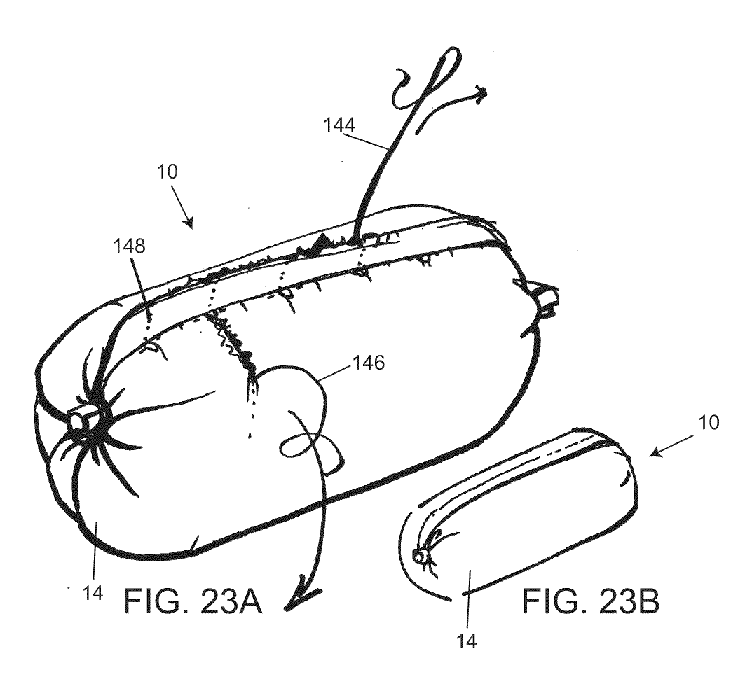

As shown in FIGS. 23A and 23B, a first tear ribbon 144 may be provided that cuts film 14 along a longitudinal path. Additional tear ribbons 146 may be provided along the length of product 10 (i.e., along a longitudinal axis) that cut film 14 along lateral paths to allow a user to only a portion of film 14 (e.g., to use only a portion of the food product). According to an exemplary embodiment, first tear ribbon 144 may be provided proximate to a flap formed by the seam coupling the ends of film 14. Flap 148 may be folded to conceal tear ribbon 144.

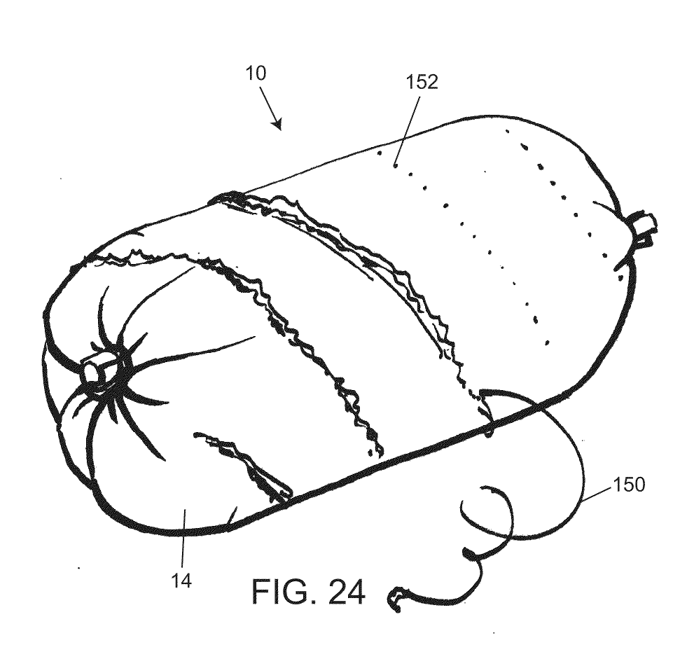

As shown in FIG. 24, a tear ribbon 150 may be provided that cuts film 14 along a spiral path 152. A user may partially unwrap tear ribbon 150 (e.g., to use only a portion of food product 12), or may peel all of tear ribbon 150 off to completely open product 10.

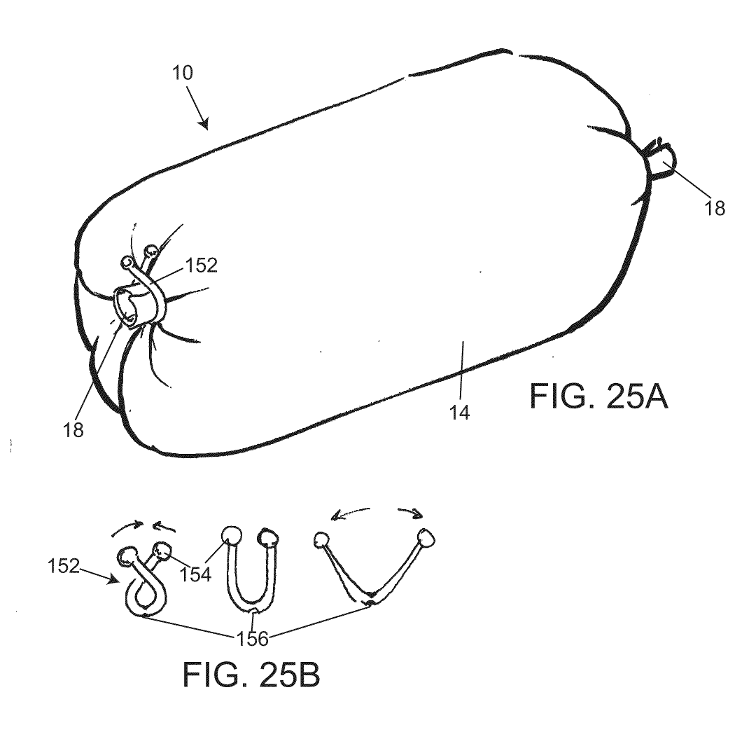

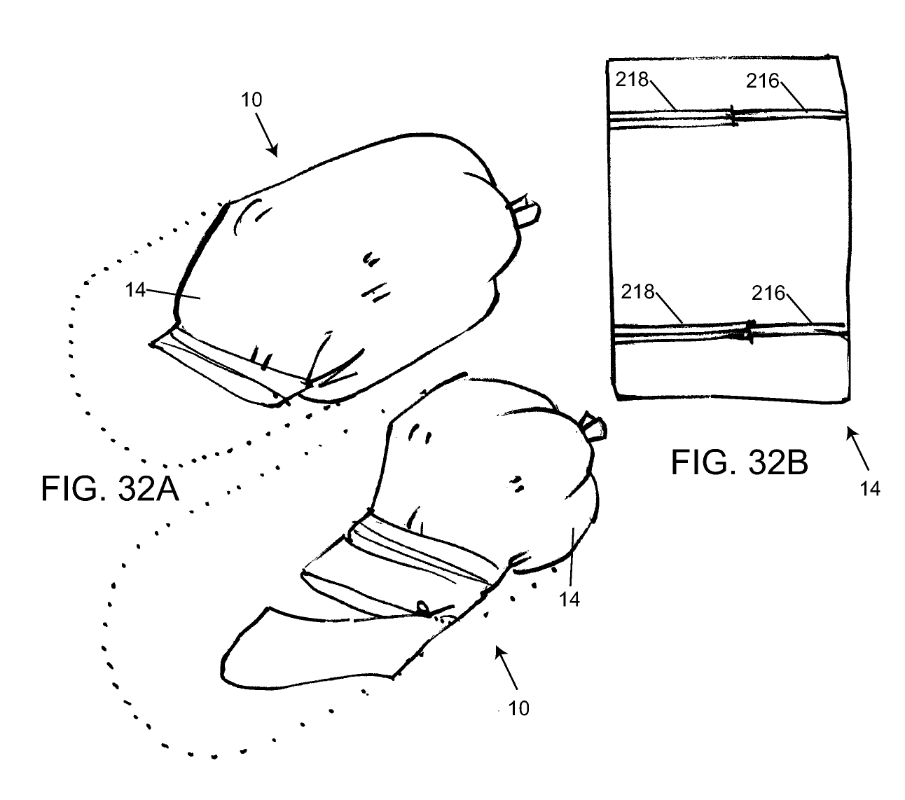

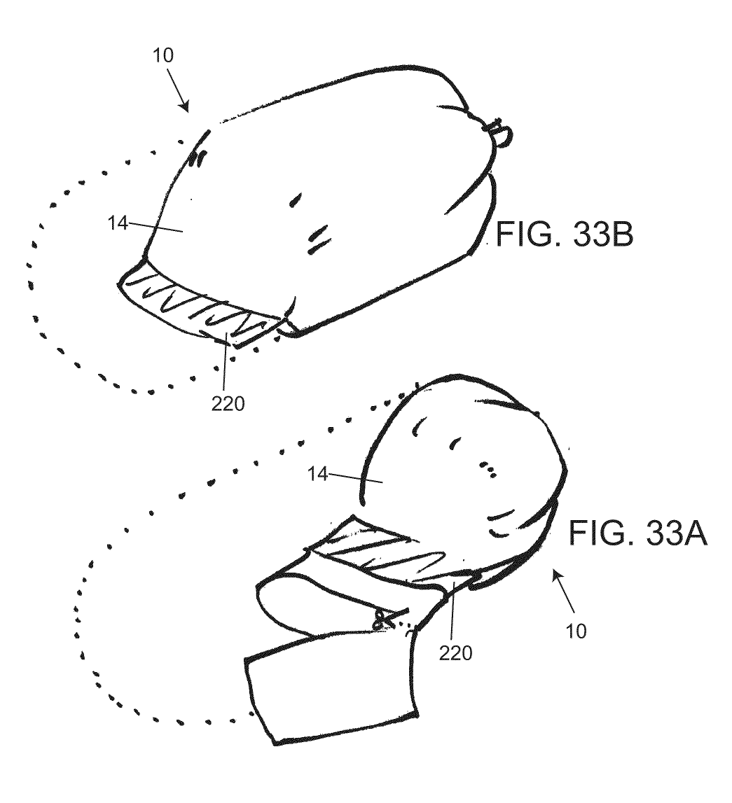

Referring now to FIGS. 25-33, a variety of clips or other closure devices may be used to gather the ends of film 14 and close film 14 to reduce the exposure of food product 12 to oxygen. The clips may be discarded after being removed or may be configured to be replaceable. Such a clip may be used to re-close a pre-packaged product after a portion of a food product has been removed. If the clip is replaced after a portion of the food product has been removed, any excess film may be removed (e.g., cut off or torn off along perforations) (see FIGS. 32-33). Both ends of the film may be secured with the same type of clip, or may be secured with different type clips.

As shown in FIGS. 25A and 25B, ends 18 of film 14 may be closed with clips 152 (e.g., metal clips, etc.). The ends of clips 152 may include ball features 154 (see FIG. 25B) or may be otherwise rounded to reduce the chance of inadvertent injury. Clip 152 may include a notch or indent 156 that reduces its cross-sectional area at a hinge portion to make it easier to open product 10 by opening clip 152.

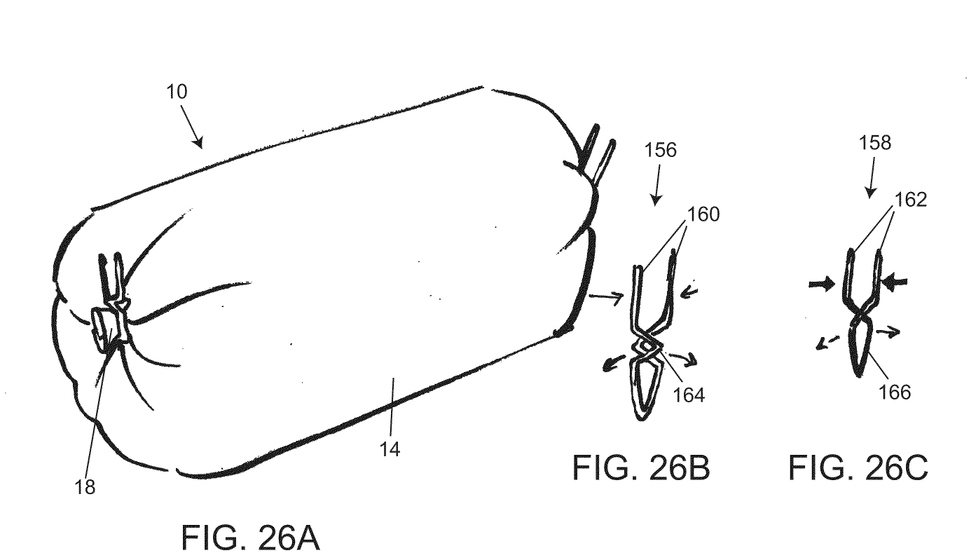

As shown in FIGS. 26A-26C, ends 18 of film 14 may be closed with metal clips 156 or 158 that hold film 14 closed with a spring force. Clips 156, 158 include two arms 160, 162 that are joined at a hinge portion. Clips 156, 158 are configured so a user may push the arms 160, 162 together at a first portion of the clip to force the two arms apart at a second portion 164, 166. Ends 18 of film 14 are captured between second portions 164, 166 of the arms 160, 162. When a user pushes down on the first portion of arms 160, 162, the end of film 14 is released from second portion 164, 166.

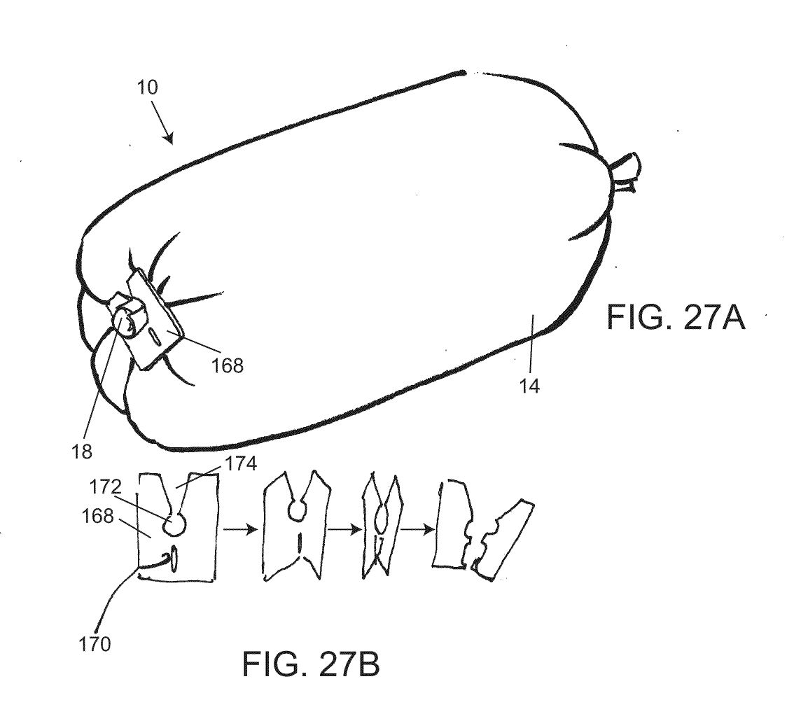

As shown in FIGS. 27A and 27B, ends 18 of film 14 may be closed with a clip 168 (e.g., a flat clip), including a weakened portion 170. Clip 168 includes an opening 172 that receives ends 18 of film 14 and a channel or passage 174 extending from one edge of clip 168 to opening 172 to allow film 14 to be pulled into opening 172. Clip 168 further includes weakened portion 170. Weakened portion 170 may be formed by an area of reduced cross section or an area with a notch or other opening formed in clip 168. Weakened portion 170 allows a user to bend and break clip 168 (see FIG. 27B), freeing the end of film 14 and allowing the user to open product 10.

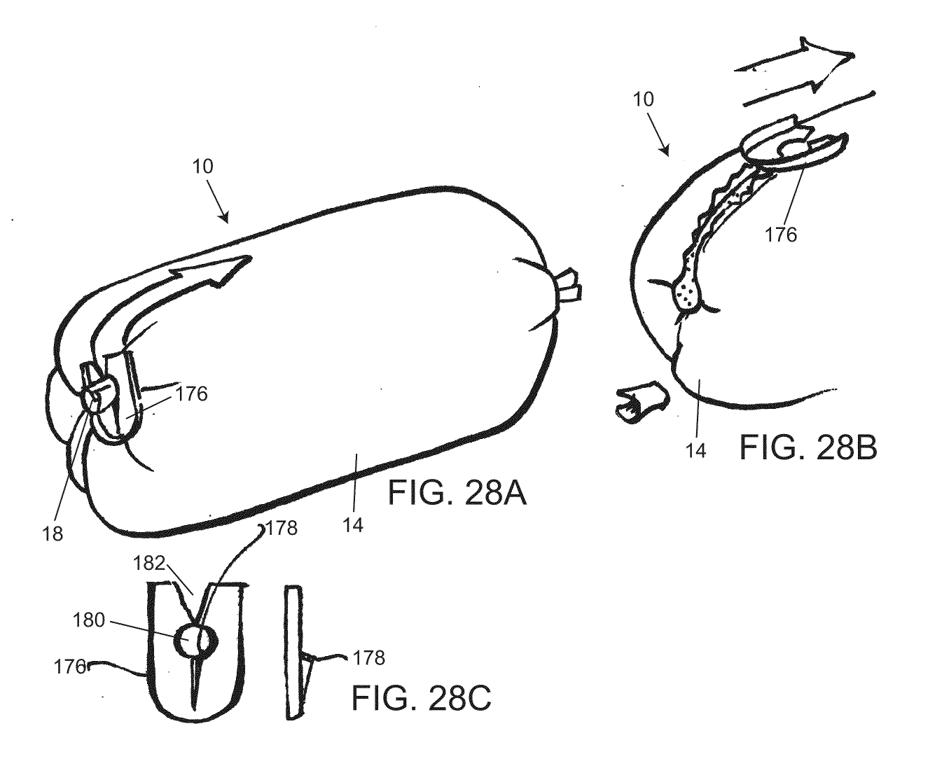

As shown in FIGS. 28A-28C, ends 18 of film 14 may be closed with a clip 176 (e.g., a flat clip, etc.) including a cutting feature shown as a blade 178. Clip 176 includes an opening 180 that receives ends 18 of film 14 and a channel or passage 182 extending from one edge of clip 176 to opening 180 to allow film 14 to be pulled into opening 180. A user grasps clip 176 and pulls it across the length of film 14 while pushing it against the surface of film 14 (see FIG. 28B). Blade 178 cuts film 14 to open the packaging. According to an exemplary embodiment, the edges of clip 176 may be raised to facilitate the grasping of clip 176 by a user.

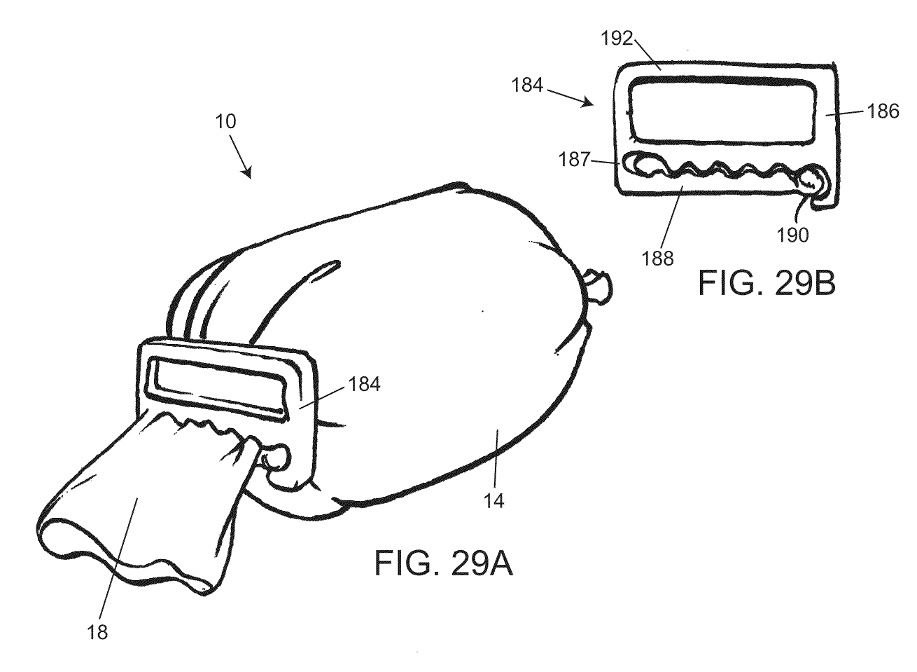

As shown in FIGS. 29A and 29B, ends 18 of film 14 may be closed with recloseable clip 184 (see FIG. 29B). Clip 184 includes a base 186 and an arm 188 coupled to base 186. The material coupling base 186 to arm 188 is a resilient material that provides a spring-loaded hinge 187. In a rest position, arm 188 traps film 14 against base 186 (see FIG. 29B). Arm 188 is further retained in the rest position by a hook and lock mechanism 190. A user may disengage hook and lock mechanism 190 and move arm 188 away from base 186 to clip 184 from film 14. According to an exemplary embodiment, base 186 includes a handle 192. According to an exemplary embodiment, clip 184 is formed as a single body.

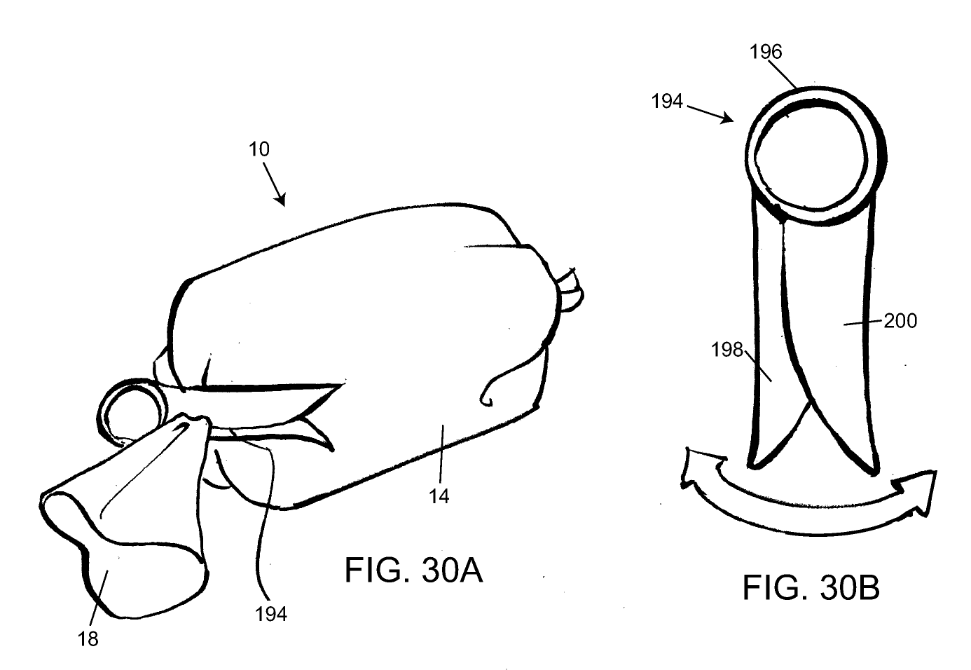

As shown in FIGS. 30A and 30B, ends 18 of film 14 may be closed with a recloseable clip 194 (see FIG. 30B). Clip 194 includes a base 196 and two scissor arms 198, 200 coupled to the base. Base 196 is a resilient material that provides a spring-loaded hinge, forcing arms 198, 200 together. In a rest position, film 14 is trapped between arms 198, 200. The ends of arms 198, 200 are shaped such that they are inclined in opposite directions. A user may grasp product 10 in one hand, and slip clip 194 over any excess of film 14 with the other hand.

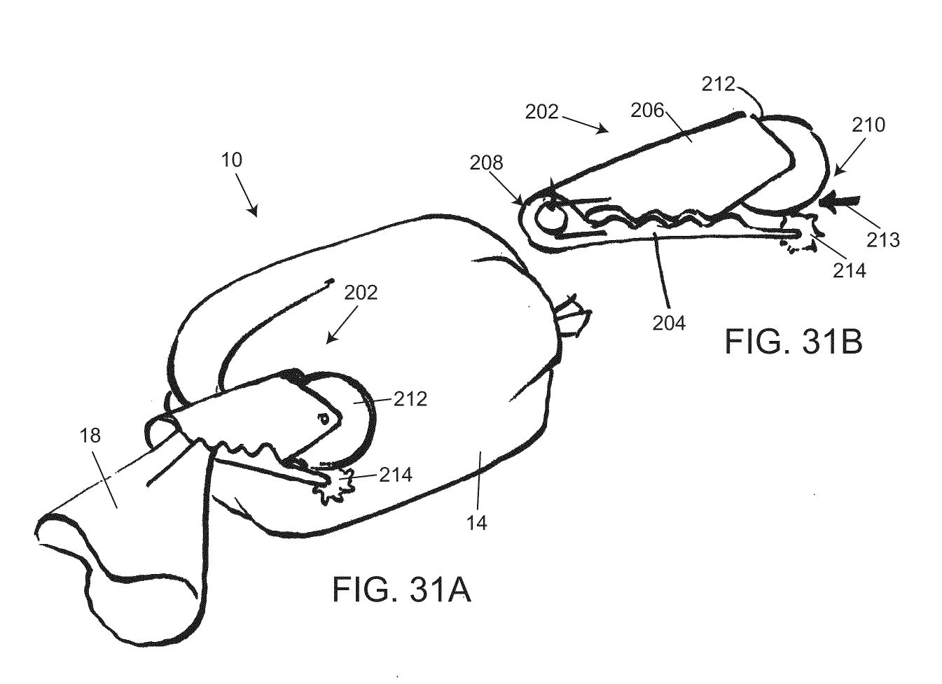

As shown in FIGS. 31A and 31B, ends 18 of film 14 may be closed with a recloseable clip 202 (see FIG. 31B). Clip 202 may be similar to clip 184 of FIGS. 29A and 29B and include an arm 204 coupled to a body 206. A spring-loaded hinge 208 may be provided to bias arm 204 toward the body 206. Clip 202 may also include a ratcheting mechanism 210 such as a pair of wheels 212, 214 opposite of hinge 208. Ratcheting mechanism 210 allows film 14 to be passed into the space between arm 204 and body 206 when arm 204 is biased against body 206 (see arrow 213), but does not allow film 14 to be removed. To film 14 from clip 202, a user must manually move arm 204 away from body 206.

As shown in FIGS. 32A-33B, the interior surface of film 14 may include one or more lateral fastening mechanisms disposed along the length of the film. According to one exemplary embodiment, a series of interlocking plastic strips 216, 218 (see FIG. 32B) may be provided at various points along the length of film 14 so film 14 may be sealed at various places along the length of product 10 as more food product is removed (e.g., by folding or rolling film 14 and interlocking strips 216 with strips 218 at one or more locations). According to another exemplary embodiment, the interior surface of film 14 may include an adhesive (see FIGS. 33A and 33B) on a sealable portion 220. In some embodiments sealable portion 220 may be provided along the full length of film 14 so product 10 can be sealed at any location and accommodate varying sizes of food products. Excess film 14 may be torn or cut off as the size of food product 12 decreases.

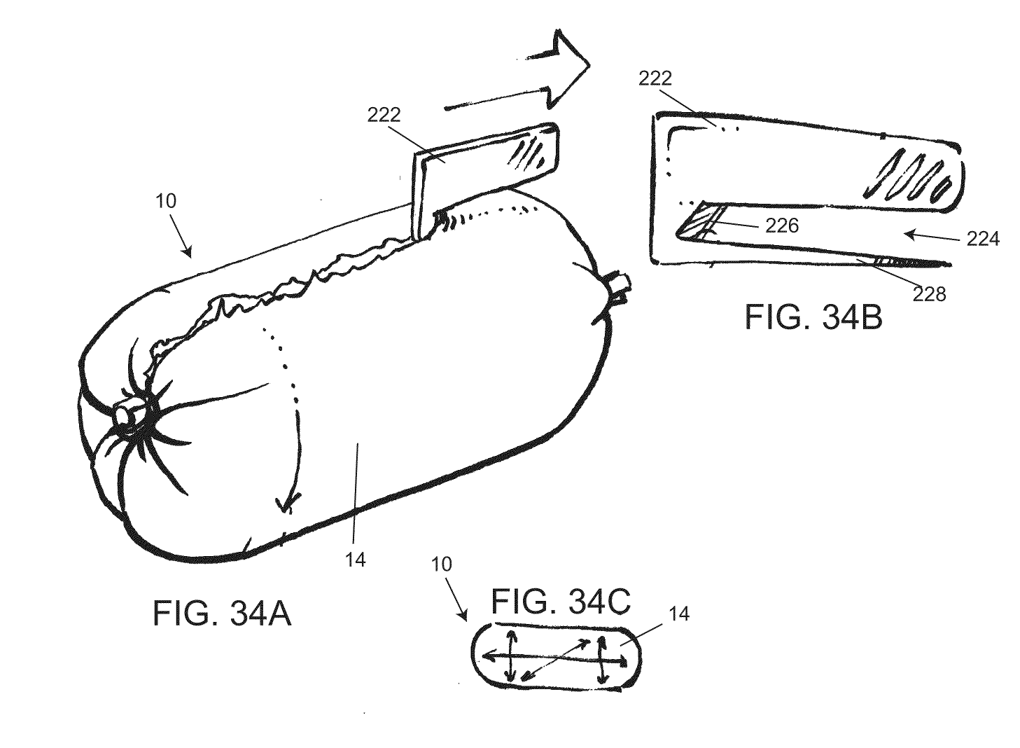

Referring to FIGS. 34A-34C, a separate cutting mechanism 222 may be provided to cut film 14. According to an exemplary embodiment, cutting mechanism 222 includes a slot 224 extending from one end of mechanism 222 and a blade 226 provided in slot 224 opposite of the open end. A spike or narrow portion 228 is provided proximate to the open end and is configured to pierce film 14. After film 14 has been pierced, cutting mechanism 222 may be dragged along the surface of the food product, forcing film 14 into slot 224 to be cut by blade 226.

### ADDITIONAL EXEMPLARY EMBODIMENTS

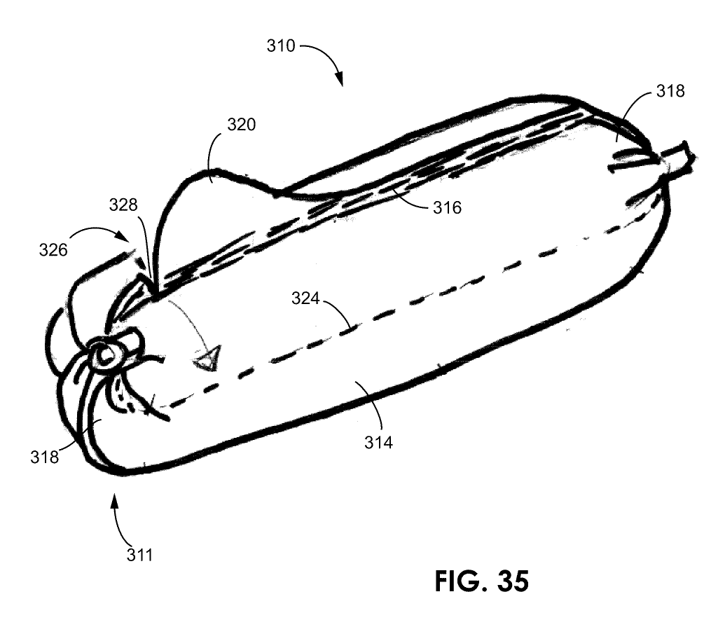

Referring now to FIGS. 35-42 a packaged food product 310 is illustrated according to an exemplary embodiment. Food product 310 may be similar to the other embodiments of food products discussed herein except where otherwise noted. Packaged food product 310 includes packaging 311 and a food product 312 (a sausage roll in this exemplary embodiment) contained therein. Similar to the packaging shown in FIGS. 10 and 20, packaging 311 shown in FIGS. 35-42 includes a film 314 that surrounds food product 312 and is closed at each end 318 by a pair of clips or other closure mechanisms or techniques to provide a barrier to the environment. According to various exemplary embodiments, any suitable closure device or mechanism may be utilized.

According to one embodiment, film 314 is a multi-layered sheet that is formed from a variety of materials such as nylon and polyester. Each of the layers may be configured for a different purpose. For example, different layers may be configured to provide puncture resistance to the film, provide tear resistance to the film, provide an oxygen barrier for the film, etc. Film 314 may be formed as a flat sheet and stored on a roll for the packaging operation.

According to one embodiment, packaging 311 includes a packaging opening system that initiates and guides tearing of the packaging to provide access to food product 312 without the use of knives, scissors, or other tools/instruments, as discussed in greater detail below. For example, due to the tear resistance properties of one or more layers of film 314, film 314 may in some embodiments be formulated or manufactured with tear properties to assist the consumer to easily open packaging 311 to access the food product 312 (e.g., orientation of the material fibers or molecular strands to allow tearing in one direction and inhibit or prevent tearing in other directions). According to an exemplary embodiment, the tear properties are directional so that the tear is orientated relative to the food product in a manner that is preferred for the food product or by the consumer. In some embodiments, directional tear properties may provide for “tear paths” (e.g., areas of film having less resistance to tearing relative to the remaining areas of film) that extend perpendicular, parallel, or otherwise to a longitudinal axis of a food product or packaging (e.g., should the food product be, for example, a generally cylindrical product having closed opposite ends). The tear paths may be parallel or non-parallel (e.g., diverging, converging, etc.). As discussed in further detail herein, directional tear properties may be provided by the formulation of the film material, by providing notches (e.g., perforations, recesses in the edges of the film material), scoring or perforations (e.g., perforations or cuts that extend fully or partially through the film material), and so on.

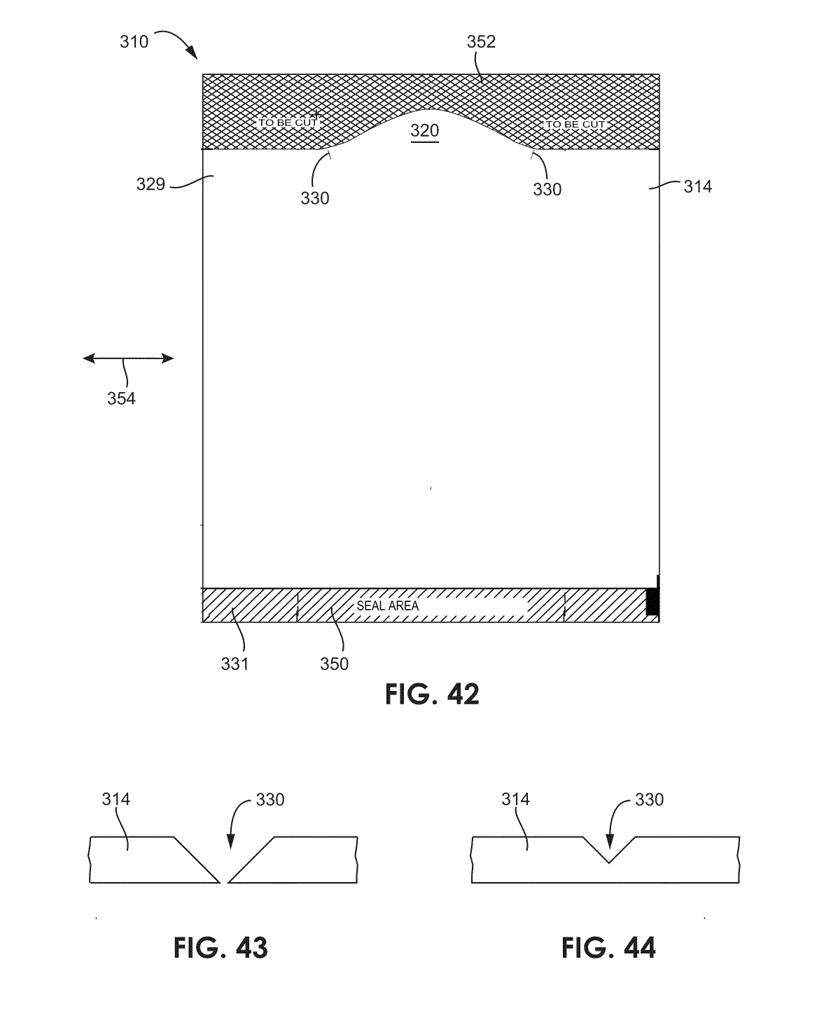

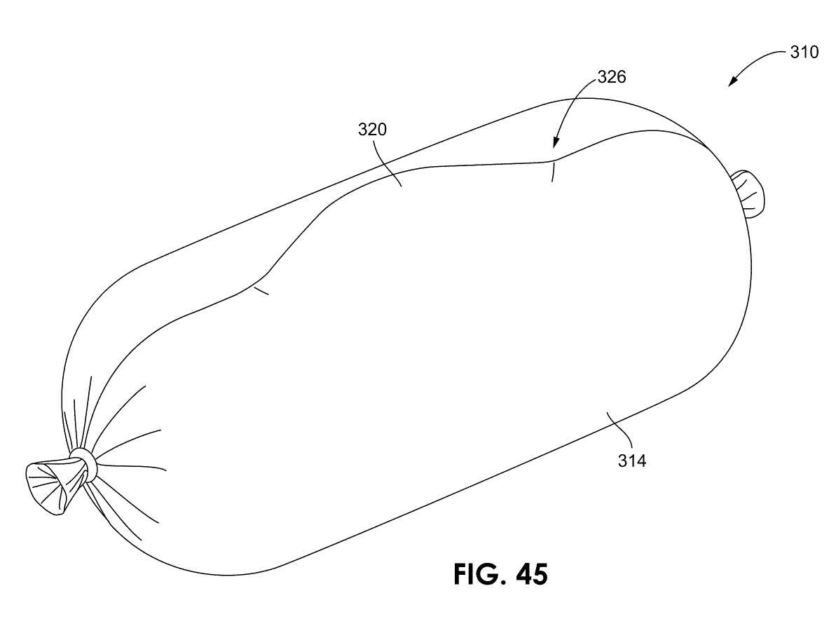

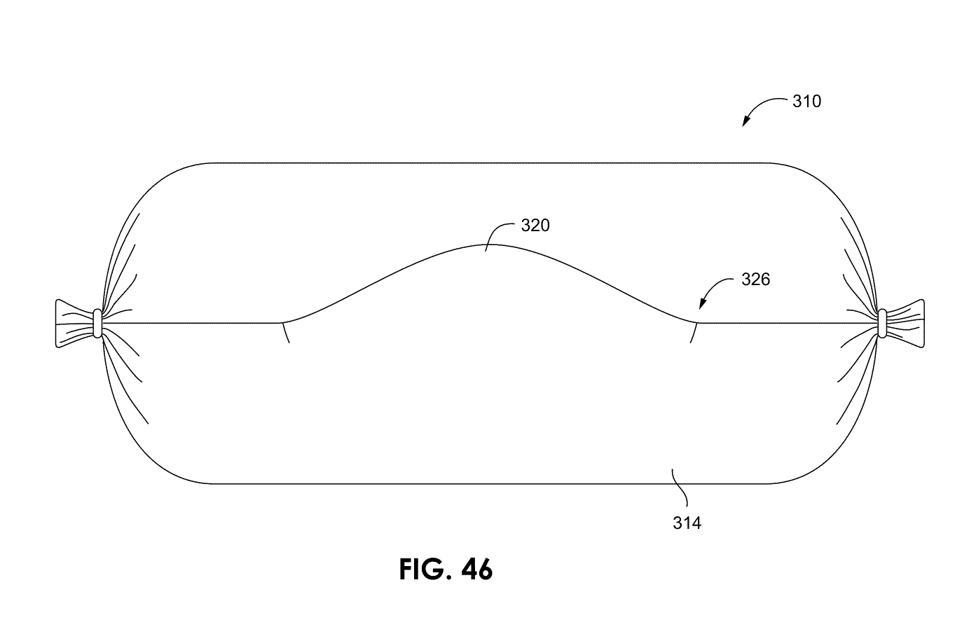

Referring to FIGS. 35-38C and 45-46, in one embodiment film 314 substantially surrounds food product 312 and is formed from a sheet having a pair of longitudinal sides 329, 331 (see FIG. 42). A seam 316 is formed by the first longitudinal side 329 overlapping and coupling to the second longitudinal side 331 (e.g., the outer major surface coupled to the inner major surface adjacent to their respective longitudinal sides). Seam 316 may be provided using a welding/heating operation, adhesive, or the like. Seam 316 extends generally parallel to the longitudinal axis of product 310. According to one embodiment, film 314 is formulated to have directional tear properties perpendicular to seam 316 (e.g., generally perpendicular to longitudinal axis of the packaged food product or across the width of film 314). The tear properties may be formulated in the film when the film is manufactured.

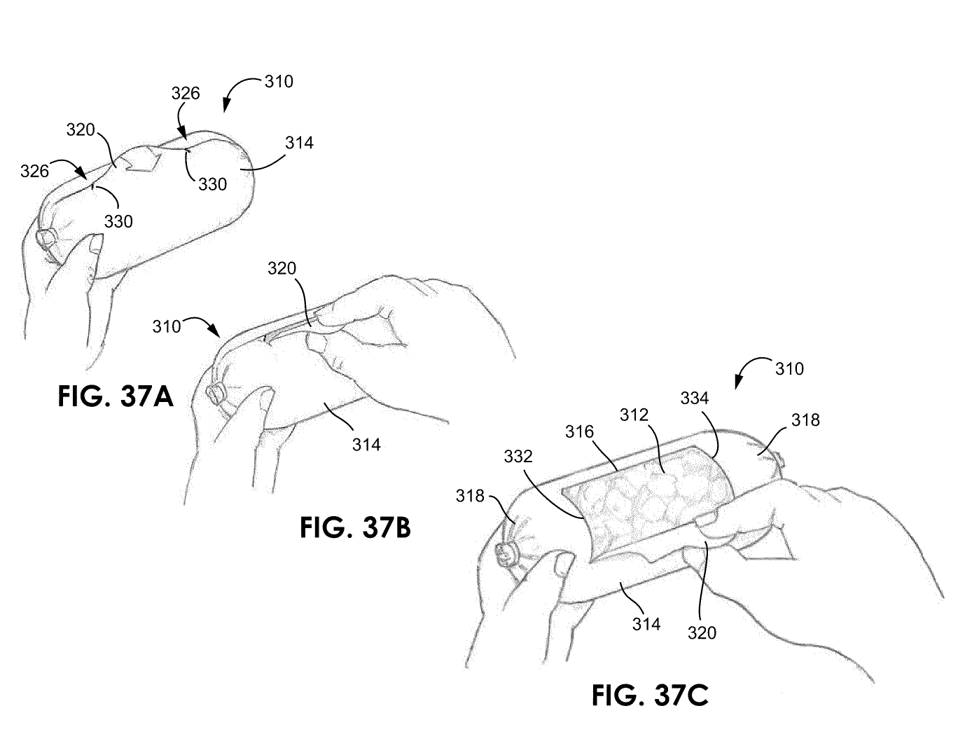

According to an exemplary embodiment, film 314 is provided with a tab 320 along a longitudinal side of film 314 that is usable by consumers such that a user may pull on tab 320 and remove all or a portion of film 314 from food product 312. In some embodiments, film 314 is configured to provide two or more generally parallel tear paths that are orientated generally perpendicular to seam 316. When a consumer pulls on tab 320, a first tear path 332 and a second tear path 334 (see FIG. 37C) are formed and progress or expand through film 314 in parallel.

Tab 320 (e.g., a user interface, etc.) extends from one of the longitudinal sides beyond seam 316. According to an exemplary embodiment, tab 320 is formed as part of film 314 and is not bonded to the sheet of film material. Alternatively, tab 320 may be provided as a separate component and bonded or otherwise attached to film 314/packaging 311. According to an exemplary embodiment, tab 320 is formed by shape or die cutting a sheet of film material. For example, after the film material is manufactured, the film material is unrolled, die cut, and then wound into a roll again. Alternatively, there are a variety of methods to form tab 320 in the film material (e.g., slitting, cutting, etc. during the initial manufacturing of the film or as part of the packaging operation). In some embodiments, tab 320 may be provided generally at a mid-point along the length of packaging 311. In other embodiments, tab 320 may be offset to one side of the length of packaging 311. Further tab 320 may be sized to extend along approximately one-half, one-third, one-fourth, or another suitable proportion of the length of packaging 311. Tab 320 may lay flat against food product 312 or project outwardly.

Adjacent to tab 320, one or more notches 328 (e.g., a tear initiator such as a recess) are provided in film 314 to assist the consumer in initiating the tearing of film 314. As such, the tear path(es) begin at the notch(es) 328 and extend at least partially around packaged food product 310. The notch(es) may be provided in film 314 by a laser cutting/scoring operation, cutting, stamping, or the like. In addition to notch 328, one or more perforations, score lines, slits, or the like may be provided to facilitate tearing of film 314.

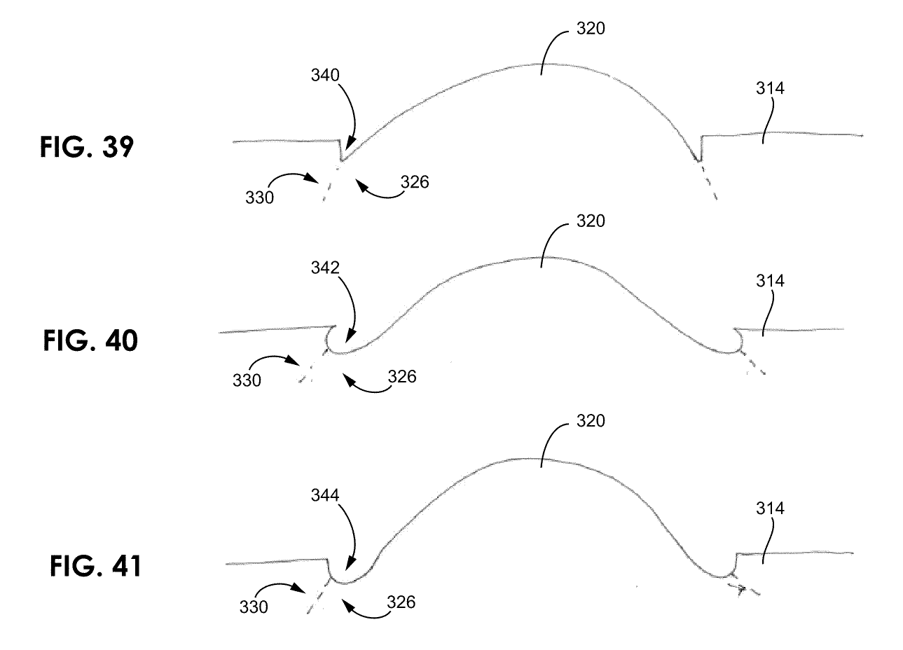

In various embodiments disclosed herein, one or more “tear initiators” 326 (e.g., weakened areas, tear-starts, stress points or stress concentration areas, etc.) such as notches 328 (e.g., notches, recesses, etc.) and/or perforations 330 (e.g., perforations, slits, cuts, apertures, etc.) may be provided to facilitate the initiation of tearing of film 314. One or more tear initiators 326 may be provided to weaken an area of film 314 and/or to concentrate forces/stresses applied to film 314 (e.g., via a user pulling on tab 320) such that tears in film 314 tend to initiate or start at the locations of the tear initiators (e.g., at the location of notch 328 and/or perforation 330). A tear initiator may take a variety of forms, including a notch or recess, such as notch 328, a perforation or slit/cut/score, such as perforation 330, or any suitable form. As used herein, a notch or recess in film 314 such as notch 328 generally refers to a feature where a portion of film 314 is, for example, removed to form a contoured portion of material (e.g., a rounded portion, a “V”-shaped portion, etc.). Exemplary notches or recesses are shown in FIGS. 39-41 as recesses 340, 342, 344. A perforation, slit, cut, score, etc. generally refers to a feature such as an aperture or hole, or a series thereof, extending through film 314 (e.g., to form a score line such as score line 324 shown in FIG. 35) to define a tear path or a tear starting point. In some embodiments, the perforations, scores, slits, etc. may extend fully through film 314, as shown in FIG. 43 (see perforation 330). In other embodiments, the perforations, scores, slits, etc. may extend only partially through film 314, as shown in FIG. 44.

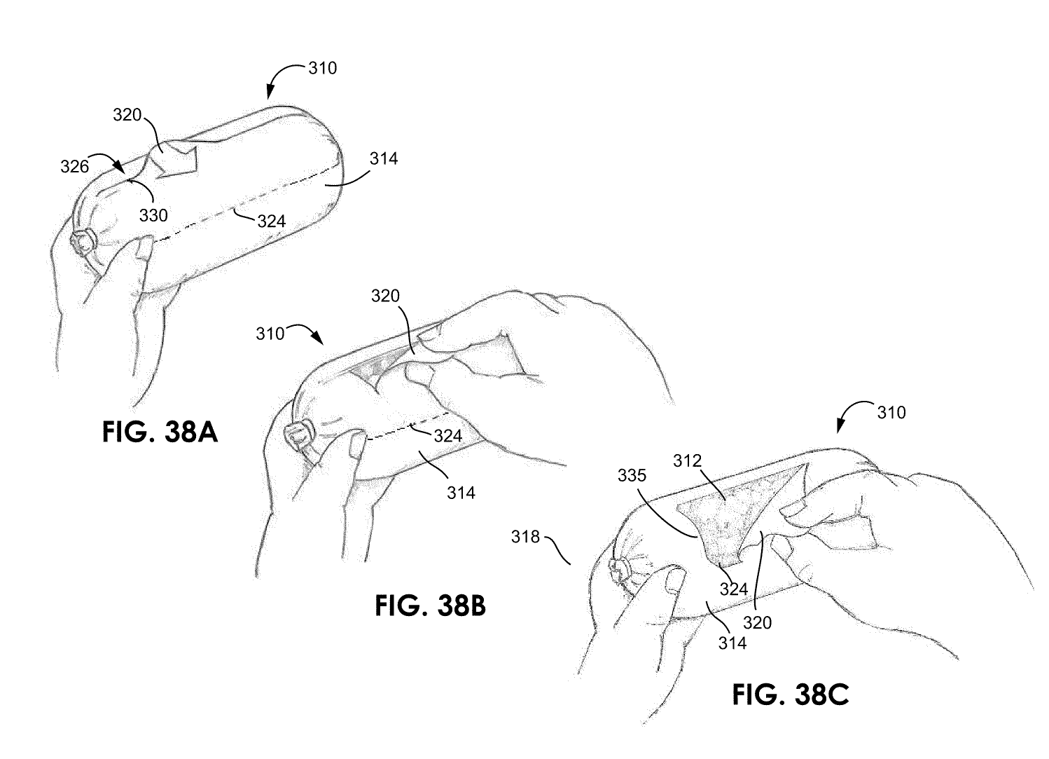

According to an exemplary embodiment, film 314 also may include a feature (e.g., a score line such as score line 324 shown in FIGS. 38A-38C) intended to provide a stop to the tearing of film 314 when being opened by the consumer. For example, it has been found that a score line that does not fully penetrate film 314 will stop a tear from proceeding past the score line. This score line may be, for example, the IntegraScore commercially available from Curwood, Inc., of Oshkosh, Wis. According to an exemplary embodiment, score line 324 extends parallel to seam 316. As discussed in further detail below, in addition to providing resisting further tearing along a tear path perpendicular to seam 316, score line 324 may provide for an additional tear path that extends, for example, parallel to seam 316, such that once a user tears film 314 from seam 316 to score line 324, the tear path then extends along score line 324.

According to one embodiment, two tear paths 332, 334 are oriented generally perpendicular to seam 316 (as well as the longitudinal axis of the packaged food product 310) and extend only partially around the perimeter or circumference of packaging 311. After a user at least partially removes or dislodges the center portion of film 314 to score line 324 food product 312 is easily removed or pushed out of packaging 311 by compressing the gathered ends 318 of film 314. Film 314 may be designed without score line 324 to allow tearing to continue so that the center portion of film 314 may be completely detached. In some embodiments, score line 324 is included so that the consumer may push food product 312 out with less direct contact with food product 312. Score line may be provided at any desired distance (e.g., a predetermined distance) from seam 316, and the distance may be varies according to the particular application.

According to an exemplary embodiment, packaging 311 may be manufactured and filled with food product 312 as part of a packaging operation. During the packaging operation, film 314 is supplied as part of a flat sheet of film material on a roll. A portion of the film material is wrapped around a hollow, cylindrical fixture (referred to as a horn) so that longitudinal sides 329, 331 overlap. A distal end 318 (e.g., relative to the roll) is closed by a clip (e.g., attached during the prior operation). Heat is applied to the overlapped longitudinal sides to form longitudinal seam 316, which forms a hollow tube defining an interior space. Food product 312 (e.g., sausage) is injected into the interior space. After being filled with food product 312, film 314 is gathered (at a predetermined location) and closed on the proximate end 318 (relative to the roll) with a closure device, commonly embodied as a metal staple or clip.

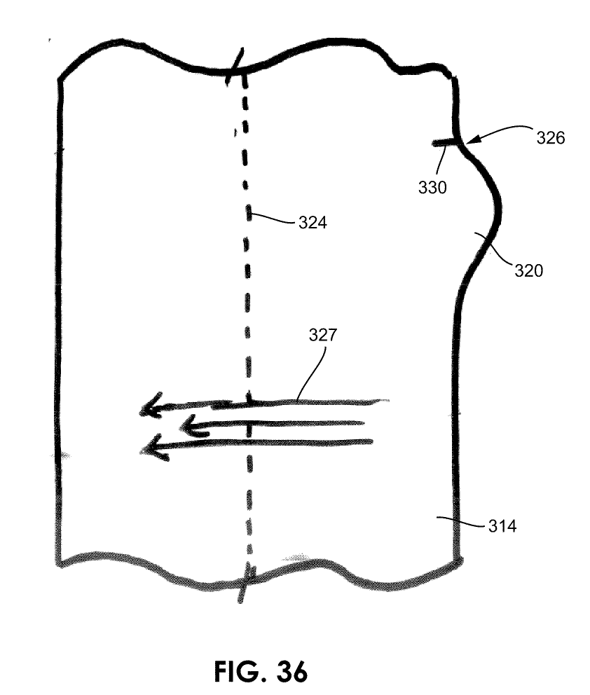

Referring to FIG. 36, film 314 is shown in a flat, or unrolled configuration (e.g., prior to seam 316 being formed and ends 318 being closed) according to an exemplary embodiment. As shown in FIG. 36, tab 320 may be formed (e.g., die cut, etc.) as part of film 314, and score line 324 may be provided along the length of film 314. Directional tear properties may be formulated into film 314 in the direction of arrow 327. In some embodiments, film 314 may be manufactured as a rolled product extending in a direction parallel to score line 324. Tab 320, perforation(s) 330, score line 324, and/or any other desirable features may be formed into the rolled product as part of a die cutting or other suitable operation. For example, referring to FIG. 42, a film material may be rolled in a direction of arrow 354. As part of a die cutting operation, area 352 may be removed, and tab 320 and perforations 330 may be formed. Alternatively, one or more features may be formed as part of a laser cutting operation. A seal area 350 is located at one longitudinal side 331 and is configured to seal with longitudinal side 329 to form the interior of the food packaging.

FIGS. 37A-38C show exemplary methods of opening the food packaging described herein. FIGS. 37A-37C show one method of opening a food product. A user (or consumer) holds the product 310 in one hand, and grasps tab 320 with the other hand (FIGS. 37A-37B). Then, the user pulls tab 320 at least partially around food product 312 to tear packaging 311 (FIGS. 37B-37C). Packaging 311 is designed with two generally parallel tear paths 332, 334. Tear paths 332, 334 may be formulated into film 314 such that additional notches, perforations, score lines, etc. are not necessary to direct the tearing of film 314 along tear paths 332, 334. Tear paths 332, 334 begin at perforations 330. In other embodiments, notches or other tear initiators may be used in place of or in addition to perforations 330. The user may then grasp ends 318, which still have packaging enclosing food product 312, and compress or squeeze packaging 311 to push food product 312 out of packaging 311 (e.g., so that the user does not directly contact food product 312). Alternatively, the user may grasp ends 318 and turn film 314 inside out to “pop” food product 312 out of packaging 311.

According to an exemplary embodiment, tab 320 and perforations 330 (or another suitable tear initiator) may be configured such that the user applies some force of pressure to the perforations 330 via tab 320 to break or weaken film 314 in preparation for the tearing step (e.g., by bending the packaging at the perforations). In other embodiments, perforations 330 or another tear initiator may be configured such that the force required to begin and maintain a tearing action along tear paths 332, 334 is relatively constant (e.g., such that a greater amount of force is not required to start the tears). As such, a tear initiator 326 may comprise various recesses, laser-formed perforations/notches, etc. (e.g., full and/or partial perforations, etc.) to provide a desired initial resistance to tearing of film 314.

FIG. 38A-38C shows another method of opening an exemplary food product. Packaging 311 shown in FIG. 38A is designed with a single tear path 335 (approximately perpendicular to the lateral axis) extending from tear initiator 326 to score line 324. Score line 324 extends approximately parallel to the lateral axis of product 310. Score line 324 as provided in this embodiment is intended to guide tearing access to the contents of packaging 311 (e.g., such that the tear path extends from seam 316 along tear path 335 to score line 324, and then along score line 324). Food product 312 may be removed in a similar manner as described with respect to FIGS. 37A-37C.

FIGS. 39-41 show additional exemplary embodiments of the configuration of file 314, tab 320, and tear initiators 326. Referring to FIG. 39, in addition to tab 320 and perforations, a recess 340 from which perforations 330 extend is provided. Recess 340 is shaped and located relative to tab 320 to concentrate the stress and forces at perforations 330. Recess 340 shown in FIG. 39 includes sides that come together in a sharp point (e.g., with a linear side generally perpendicular from the longitudinal side of the film sheet). Perforations 330 then extend from this sharp point. Recess 342 shown in FIG. 40 includes curved sides and an undercut defined by the longitudinal side of film 314 adjacent to tab 320. Recess 344 shown in FIG. 41 is similar to the recess of FIG. 40, except recess 344 does not have an undercut. In some embodiments, the perforations shown in FIGS. 40 and 41 are off-center (e.g., offset from the bottom/valley or minimum point of the recess). In further embodiments, the perforations in

FIGS. 39-41 are at an acute angle relative to the longitudinal side of film 314 (i.e., between 0 degrees and 90 degrees). Further yet, the perforations may intersect with the recess, or alternatively, there may be a portion of film 314 provided between the perforations and the recess. The size, shape, and orientation of the recesses and/or perforations may be varied to suit any particular application.

It is important to note that the construction and arrangement of the elements of the openable food package as shown in exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, materials, colors, orientations, etc.) without materially departing from the novel teachings and advantages of the subject matter recited in the embodiments. For example, for purposes of this disclosure, the term “coupled” shall mean the joining of two members directly or indirectly to one another. Such joining may be stationary in nature or movable in nature. Such joining may be achieved with the two members or the two members and any additional intermediate members being integrally formed as a single unitary body with one another or with the two members or the two members and any additional intermediate member being attached to one another. Such joining may be permanent in nature or alternatively may be removable or releasable in nature. Such joining may also relate to mechanical, fluid, or electrical relationship between the two components. Accordingly, all such modifications are intended to be included within the scope of the present disclosure as defined in the appended claims. The order or sequence of any process or method steps may be varied or re-sequenced according to alternative embodiments. Other substitutions, modifications, changes and/or omissions may be made in the design, operating conditions and arrangement of the exemplary embodiments without departing from the spirit of the present disclosure.

What is claimed is:

1. A packaging for a food product configured to be easily openable, the packaging comprising:
a film substantially surrounding the food product and formed from a sheet having a first longitudinal side and a second longitudinal side;
a seam formed by the first longitudinal side overlapping and bonding to the second longitudinal side;
a tab extending beyond the seam from one of the first longitudinal side and the second longitudinal side; and
at least one tear initiator provided in the film adjacent the tab, the at least one tear initiator defining a starting point for a tear path, the tear path extending generally perpendicularly from the seam.

2. The packaging of claim 1, wherein directional tear properties are formulated in the film when the film is manufactured, the directional tear properties configured to facilitate tearing of the film along the tear path.

3. The packaging of claim 2, wherein the tear properties comprise perforations provided in the film.

4. The packaging of claim 1, wherein the at least one tear initiator comprises a first notch and a second notch provided on opposite sides of the tab.

5. The packaging of claim 4, wherein first and second tear paths extend from the first and second notches, the first and second tear paths extending generally parallel to each other.

6. The packaging of claim 1, wherein the film is configured to resist further tearing along the tear path at a predetermined distance from the seam.

7. The packaging of claim 6, further comprising a score line provided in the film configured to resist further tearing along the tear path, the score line provided at the predetermined distance from the seam and extending generally parallel to the seam.

8. The packaging of claim 7, wherein the film is configured to tear along the score line upon the film being torn along the tear path to the score line.

9. The packaging of claim 1, wherein the tear initiator comprises a recess and a perforation extending from the recess.

10. A packaging for a food product, the packaging comprising:
a film substantially surrounding the food product and formed from a sheet having a pair of longitudinal sides;
a seam formed by the longitudinal sides overlapping and bonding to each other;
a tab extending from one of the longitudinal sides beyond the seam;
first and second tear initiators provided in the film and located on opposite sides of the tab;
wherein the film is formulated to have directional tear properties so that a first tear path extending from the first tear initiator and a second tear path extending from the second tear initiator are formed when the packaging is opened by pulling on the tab, the first and second tear paths extending generally parallel to each other.

11. The packaging of claim 10, wherein the first and second tear initiators comprise laser-formed perforations.

12. The packaging of claim 11, wherein the perforations extend partially through the film.

13. The packaging of claim 10, wherein each of the first and second tear initiators comprises a recess formed in the film adjacent the tab, and at least one perforation extending from the recess.

14. The packaging of claim 10, further comprising a score line extending parallel to the seam, the score line providing resistance to further tearing of the film along the first and second tear paths.

15. The packaging of claim 14, wherein the film is configured to tear along the score line upon a user tearing the film along the tear paths to the score line.

16. A method of forming a packaging for a food product, the method comprising:
providing a film material;
die cutting the film material to form two longitudinal sides, one of the longitudinal sides comprising a tab portion, the longitudinal sides being configured to be sealed together to form a seam;
providing directional tear properties in the film material, the directional tear properties defining at least one tear path extending perpendicular to the seam.

17. The method of claim 15, further comprising forming a score line along a longitudinal access of the film material.

18. The method of claim 15, wherein the tear path extends perpendicularly from the seam to the score line and along the score line.

19. The method of claim 15, wherein die cutting the film material to provide directional tear properties comprises die cutting at least one tear initiator into the film material adjacent the tab.

20. The method of claim 19, wherein the tear initiator comprises at least one of a recess and a perforation.
